(19) United States
(12) Patent Application Publication
(10) Pub. No.: US 2016/0092647 A1
(43) Pub. Date: Mar. 31, 2016

(54) METHOD FOR RECORDING MEDICAL INFORMATION OF A USER AND FOR SHARING USER EXPERIENCE WITH SYMPTOMS AND MEDICAL INTERVENTION

(71) Applicants: Muralidharan Pillapayam Narasimhachari, Chennai (IN); Radhika Muralidharan, Frisco, TX (US)

(72) Inventors: Muralidharan Pillapayam Narasimhachari, Chennai (IN); Radhika Muralidharan, Frisco, TX (US)

(21) Appl. No.: 14/499,302

(22) Filed: Sep. 29, 2014

(51) Int. Cl. G06F 19/00

(52) U.S. Cl. CPC G06F 19/3431; G06F 19/322; G06F 19/3487

(57) ABSTRACT

The present invention relates to an integrated system of ‘Electronic Medical Record for Individuals’ (EMRI) and ‘Patient Information Exchange (PIE) to perform a method for creating and recording medical information of a user and for sharing user experience with symptoms and medical intervention details. In this method for creating and recording medical information of the individual user, comprehensive health information of the individual user in the user interface module is organized and prepared based on the personal details, the health details, the symptoms, the treatment details, the health reports and the medical insurance details of the individual user through a user interface module of the EMRI module. The health information of the individual user are tracked and displayed from the user interface module into a doctor interface module of the EMRI module. Such systems and methods facilitate easy availability of comprehensive and chronological medical records or health information of the user and easy public sharing of the user experience with symptoms and medical intervention benefiting the society at large through such dissemination. Further, it achieves effective diagnosis and determination of right course of medical intervention to enhance the quality of life and mitigating trauma for the user, and also minimizes the information gap between the patients and the doctors for effective diagnosis.

### FIELD OF THE INVENTION

The present invention generally relates to a medical information recording and management system. The present invention relates in more particular to an integrated system of ‘Electronic Medical Record for Individuals’ (EMRI) and ‘Patient Information Exchange (PIE) to perform a method for creating and recording medical information of a user and for sharing user experiential learning with symptoms and related medical intervention, which is capable of enhancing the quality of life and mitigating trauma of any individuals.

### BACKGROUND OF THE INVENTION

In medical information management system, maintenance of records of history and past information about a user i.e. patient plays a very essential role to provide accurate diagnosis and preventive healthcare of the patient. In particular, it is necessary to monitor appropriate preventive healthcare from childhood to maintain good health of any individuals. Also, while consulting with a doctor for an abnormality, it is required to provide relevant and factual information, which can facilitate effective diagnosis. In general, the patient informs about the past medical history and symptoms to the doctor based on the remembrance and perhaps some disorganized medical records, which can lead to inadvertent miss in providing key information and further lead to inaccurate diagnosis. Also, there are other communication gaps as a result of not being aware of past health details or not in a position to communicate or language barrier or accent variation, etc. Well prepared medical documentation always helps alleviate in both preventive healthcare and diagnosis for an abnormality.

Doctors generally grasp the patient's health background and issues from inquiring questions and medical records, i.e. relevant, chronological and complete information in verbal or document form for diagnosis and medical intervention. Accordingly, patients need to share the information within a reasonable time so that less of doctor's time is expended in grasping patient's health. Conventionally, physical records of patient health information are maintained for diagnosis, where the chances of misplacing of medical documentations are high in these physical records, which lead to ineffective diagnosis in the absence of past history of patient health information.

In general, doctors have to diagnose correctly with available information from the patients as well as within a reasonable time frame, and have to rely on the medical records and verbal information provided by patients during the process of diagnosis. However, the information and details provided by the patients may not always be comprehensive, chronological and well linked to provide the doctors with sufficient inputs to carry out the diagnosis. Also, it causes confusion due to multiple records, and is difficult, time consuming to peruse and understand the patient's case and the underlying issues or causes or background. In some cases, patients are not able to precisely describe the abnormality/the symptom(s)/its uniqueness or miss sharing some key symptom(s) unless the doctor seeks answer through searching questions. Yet another challenge is to understand the patient's language and accent. In some cases the patients are not able to communicate or not in a position to communicate or unclear in communication. Also the key points of a verbal communication may be missed or lost as it may not be repeated by the patients unless asked for again. Also sometimes patients may be embarrassed to share some sensitive and personal information through verbal communication, more so to a doctor of the opposite gender. Thus, the structured, comprehensive, chronological, and well linked medical information and records play a significant role to bridge the communication gap between the doctors and the patients.

Nowadays, even many computing systems are used in a wide variety of medical applications such as in hospitals, pharmaceutical industries, system for patient care in hospitals, medical records etc. Most hospitals maintain records in their computing systems related to admission, details of procedure and treatment, records of test results, discharge summary etc. However, still it is not able to provide comprehensive, chronological and well linked medical information and records to achieve effective diagnosis. Also such information and medical records may be in the archives of the hospital and may not be accessible from another hospital or another location. The absence of comprehensive, chronological and well linked medical information and records can lead to many difficulties such as the need to ask more inquiring questions, taking additional time for inquiring or to review bulky reports, to assume or accept the patient's memory recall and verbal response, to diagnose with several incomplete information such as those related to the past macro health issues, complete case history (from the origin) and trend, current symptoms/its uniqueness, test(s) undertaken, medicines being taken, allergies, habits and work hazards, family health, etc. Additionally, it is also difficult in quick traceability of reports, to take that extra time to let the patient undergo repeat tests due to non-availability of previous test reports, etc. These difficulties can further lead to ineffective diagnosis on the basis of available information, i.e. not providing 100% correct information to facilitate the diagnosis and medical intervention process.

Further, lack of comprehensive, chronological and well linked medical information and records can also cause many difficulties for the patients such as the need to recall from memory if information sought by the doctor(s) is not readily available; unable to present a cohesive story, present correct or complete information about the case or tests or medicines or its effectiveness; information about allergies of self or childhood health issues or allergies of blood relatives or habit; exposure to undesirable situations; family health issues; taking extra time of self and the doctor for responding; make available pertinent information, reports in a short time as well as not be able to communicate clearly about the symptoms, the uniqueness about symptoms; the recent environmental exposure that may be the cause of the symptom/abnormality; change or details of habits; professional hazards; not in a position to communicate at all; inability to communicate due to language difficulty or accent or anxiety or shyness, etc. The other difficulties are to undergo repeat test(s) due to non-availability of previous test(s) reports, taking another appointment (post-test), expending resources arising out of this etc. Further, absence of such a comprehensive, chronological and well linked ‘Medical information/record’ can also lead to other difficulties such as planning, implementing a structured preventive health plan or miss preventive health schedules, maintenance of records of preventive health, inability to track childhood immunization or childhood development that may lead to impairment of the ability of the child, incomplete pregnancy related information and records (for women), miss to track health insurance payments/receipts, etc.

In addition, in case of symptoms related information, there are many shortcomings and challenges faced by the general user, i.e. not documenting information related to ‘real life ‘experiential learning with symptoms and related medical intervention’ (hereafter preferably called as ‘My experiences with symptoms’) directly by patients' or their ‘near and dear’, non sharing of such experience for the larger benefit of the society, absence of stratified cases of shared ‘My experiences with symptoms’ that closely match a patient's profile, symptom(s) encountered and the learning from the ‘medical intervention journey’, derive some meaningful information (such as the need to seek early medical intervention from a qualified medical professional, simple preventive health practices, highlighting importance of structured medical documentation for self etc) benefiting the individual seeking such information. Also, lack of awareness about symptoms and/or their uniqueness can lead to ignorance of early stages of symptoms or ignoring the symptoms in their early stages that delay in reaching a qualified medical professional well in time.

Further, there is lack of comprehensive records of symptoms to recognize the underlying abnormality (disease or illness), lack of ready reference of many valuable inputs documented from patients' experience in dealing with different types of symptoms {such as medical procedure (treatment) undertaken, effectiveness of treatment, preventive/corrective steps that may be beneficial} in a structured formatting to derive meaningful information, lack of ready reference of valuable inputs related to prevention or mitigation of an abnormality or symptoms, lack of information related to abnormalities (disease or disorder) with the patients' experience in dealing symptoms and the doctor diagnosis, and lack of information related to abnormalities in specific to the group/sub group/profile of the patients. The patient has also learnt in a hard and painful way during the journey of this medical intervention and thus there is no platform to share the learning in dealing with symptoms for the benefit of the society at large. Thus, there are many challenges faced by the general public in symptoms awareness, describing symptoms(s) with their uniqueness, recognizing the importance of early stages of symptom(s), absence of knowledge of possible severity of the impact of the symptom(s), the difficulty that may be caused (to both the patient and the doctor) as a result of delay in reaching out to a doctor, experiential learning in dealing with symptoms, systematic documentation of the experience, platform for sharing or meaningful searching, using the inputs to enhance ones knowledge, prevent or mitigate trauma by early medical intervention, appropriate preventive checks, as well as minimize cost of medical intervention.

The doctor's diagnosis and medical intervention are mostly beginning in many cases only when the patient consults after the initial identification of symptom or health issue, with/without past medical details/history or after much delay due to lack of awareness about the symptoms, its uniqueness or its severity. In some cases, due to lack of awareness, patients are not able to precisely describe all the symptoms or miss to share some key symptoms or the uniqueness of symptoms unless inquired in depth by the doctor, which leads to the absence of comprehensive information needed for successful medical intervention for a given group/sub group/profile of a patient and non-availability of desired information/records to necessitate the need for additional tests with additional costs during the course of diagnosis that results in delay in the start of medical intervention process. Thus, it results in many drawbacks and difficulties in the process of diagnosis to determine the right course of medical intervention for the patients due to lack of awareness of patients about symptoms, incomplete information on symptoms, non-availability of pertinent medical records and lack of documented details of successful medical intervention with sub group/group/profile of the patient.

In the process of medical intervention and recovery, the individual (patient) has to first recognize the symptom(s) and realize the need for medical intervention before reaching out to the doctor. At this point the doctor begins the process of diagnosis and medical intervention by perusing records, seek answers through inquiring questions, physically examine/observe the patient and conduct tests to confirm the symptoms, abnormality and its underlying causes. The doctor may accordingly provide medical intervention. After undertaking the recommended medical intervention, it is generally understood that the effectiveness of the medical intervention has to be confirmed by the patient or through further tests. Hence, for future effective diagnosis of the same patient or other patients with same symptoms, for the benefit of the society, it is required to learn and share such medical intervention journey from the point of ‘Symptom discovery/recognition/consultation with doctor(s)/diagnosis/medical intervention/confirmation of effectiveness of medical intervention/symptom(s) alleviation/complete cure’. Through such learning, many patients can also have recognized that certain steps (preventive/corrective) could have helped them avoid/mitigate the trauma and hence cost and agony for self and the family. By timely sharing of such experience in a structured manner, every patient can deliver a great service to the society and people at large, as sometimes the damage done due to delay in medical intervention can prove to be irreversible and very expensive or traumatic. Besides this the society at large gets enhanced knowledge about the importance of types of symptoms, their uniqueness and the importance of dealing with symptoms (associated with specific body region/body parts) without delay. Data analysis from such shared information may also benefit many other professionals such as doctors, teachers, medical students, those doing medical research, targeted medical attention for specific groups I sub groups, new medicine discoveries etc.

With reference to the conventional and existing approaches, it is very difficult to effectively diagnose and determine the right course of medical intervention for the patients due to incomplete and disorganized information about the patients. In the process of medical intervention and recovery, it is necessary that the patient should consult a qualified medical professional for diagnosis and medical intervention as early as possible as well as the doctor should have ready availability of comprehensive information and records of symptoms, their uniqueness and past medical intervention history to correctly diagnose and proceed with medical intervention. There is always a need to diagnose the abnormality or causes correctly and recommend the correct medical intervention in the shortest possible time. Thus, it is necessary to provide a simple and easy solution of recording the comprehensive, chronological and well linked ‘Medical information or record’ to address the above-mentioned difficulties and disadvantages. Further, there is a significant need for a single platform (web based platform) for sharing of patients ‘Experiential learning in dealing with symptoms’ outlining the learning acquired in the entire ‘Medical intervention journey’, where the sharing of such learning and presenting of the experiences in a structured, stratified and systematic manner can help in prevention of occurrence or trauma mitigation of an abnormality.

Therefore, it is desirable to provide an integrated system of ‘Electronic Medical Record for Individuals’ (EMRI) and ‘Patient Information Exchange (PIE) to perform a method for creating and recording medical information of a user and for sharing user experience with symptoms and medical intervention details, which is capable of overcoming the aforementioned drawbacks, i.e. addressing all the above requirements of the patients and the doctors. In particular, it is desirable to facilitate easy availability of comprehensive and chronological medical records or health information of the user as well as easy public sharing of this medical intervention of the user with symptoms and experiences, which results in effective diagnosis and determination of right course of medical intervention to enhance the quality of life and mitigating trauma for the user/others. It also minimizes the information gap between the patients and the doctors for effective diagnosis.

### SUMMARY OF THE INVENTION

An object of the present invention is to provide a method for creating and recording medical information of an individual user in an integrated system of Electronic Medical Records for Individuals (EMRI) module and Patient Information Exchange (PIE) module, which facilitates easy availability of comprehensive and chronological medical records or health information of the user.

An another object of the present invention is to provide a method for sharing and searching user ‘experiential learning with symptoms and related medical intervention’ details in an integrated system of Electronic Medical Records for Individuals (EMRI) module and Patient Information Exchange (PIE) module, which facilitates easy public sharing of the user experience with symptoms and medical intervention.

A further object of the present invention is to provide an integrated system of Electronic Medical Records for Individuals (EMRI) module and Patient Information Exchange (PIE) module, which is capable of achieving effective diagnosis and determination of right course of medical intervention to enhance the quality of life and mitigating trauma for the user. A further object of the present invention is to provide an integrated system of Electronic Medical Records for Individuals (EMRI) module and Patient Information Exchange (PIE) module, which minimizes the information gap between the patients and the doctors for effective diagnosis.

According to first embodiment of the present invention, which achieves the objectives, relates to a method for creating and recording medical information of an individual user in an integrated system of Electronic Medical Records for Individuals (EMRI) module and Patient Information Exchange (PIE) module. The method comprises the steps of collecting and recording personal details and health details of the individual user from the birth, through a user interface module of the EMRI module. Symptoms, treatment details, and health reports of each health consultation of the individual user are updated in the user interface module. Family health details of the individual user are recorded in the user interface module. Medical insurance details of the individual user are registered in the user interface module. Comprehensive health information of the individual user in the user interface module is organized and prepared based on the personal details, the health details, the symptoms, the treatment details, the health reports and the medical insurance details. Auto reminder of pending health issues is displayed for the individual user in the user interface module. The health information of the individual user are tracked and displayed from the user interface module into a doctor interface module of the EMRI module. Thus, the method facilitates easy availability of comprehensive and chronological medical records or health information of the user. It also minimizes the information gap between the patients and the doctors for effective diagnosis.

According to first embodiment of the present invention, the comprehensive and chronological health information of the individual user includes a list of information about personal, present abnormalities, symptoms, consultation and treatment details, prescribed medicines, health test reports, allergies, habits and work hazards, family health, preventive health, childhood development and pregnancies.

According to first embodiment of the present invention, the comprehensive health information of each individual user is stored in a database storage device that is connected to the user interface module and the doctor interface module.

According to first embodiment of the present invention, the information related to account, abnormalities, reports, allergies, habits and work hazards, family health, preventive health, childhood development, pregnancies and medical insurance of the individual user are entered, stored and viewed in each sub-module of the user interface module.

According to first embodiment of the present invention, the doctor interface module is coupled with the user interface module to receive and view the health information of the user from the user interface module.

According to first embodiment of the present invention, the information related to abnormalities, reports, allergies, habits and work hazards, family health and pregnancies of the individual user in the user interface module are exported, accessed and viewed in each sub-module of the doctor interface module.

According to first embodiment of the present invention, the user interface module is preferably segmented into abnormalities sub-module, reports sub-module, allergies, habits and work hazards sub-module, family health sub-module, preventive health sub-module, childhood development sub-module, pregnancies sub-module, medical insurance sub-module and manage account sub-module.

According to first embodiment of the present invention, the pregnancies sub-module is segmented from the user interface module only when the gender is marked as ‘Female’ at the time of creating an account in the EMRI module.

According to first embodiment of the present invention, each sub-module of the user interface module is provided with a help section to assist the user while recording the details in each sub-module.

According to first embodiment of the present invention, the details recorded in each sub-module are generated and displayed in the form of comprehensive tables in the user interface module.

According to first embodiment of the present invention, the abnormalities sub-module is configured to generate and store comprehensive information related to abnormalities of the individual user, which preferably relates to a chronological list of abnormalities, abnormality background, symptoms, consultation and treatment details, medical intervention details, test details, prescribed medicines and case history of individual abnormality.

According to first embodiment of the present invention, the abnormalities sub-module is preferably composed of abnormalities history section, symptoms and treatment detail elements, medicines prescribed elements and symptoms and treatment history elements.

According to first embodiment of the present invention, the details of age wise abnormalities of the individual user from birth are recorded in the abnormalities history section for generating a chronological and comprehensive table of abnormalities of the individual user in the user interface module.

According to first embodiment of the present invention, the abnormalities history section is preferably composed of fields of abnormalities and age when diagnosed.

According to first embodiment of the present invention, the symptoms and treatment detail elements are configured to record every consultation details of each of the abnormalities entered in the abnormalities history section for generating a comprehensive table of symptoms and treatment details with abnormality description.

According to first embodiment of the present invention, the symptoms and treatment detail elements are preferably composed of fields of current symptoms and issues, exposure to undesirable conditions, hospital or patient reference number, doctor name, test taken, observation and diagnosis, medical intervention or procedure, medicines prescribed, doctor's advice, effectiveness of medicines or medical intervention and date of update.

According to first embodiment of the present invention, the medicines prescribed elements are configured to record details of medicines prescribed during each consultation and preferably composed of fields of medicine and strength, dosage unit, with respect to food, morning, noon, night, anytime of the day, and number of days along with abnormality description, doctor name and date of consulting.

According to first embodiment of the present invention, the symptoms and treatment history elements are automatically generated for each abnormality by collating information from details entered in the symptoms and treatment detail elements and the medicines prescribed elements, which provides chronological details of the treatment and medical intervention of the abnormality.

According to first embodiment of the present invention, the details regarding medical reports are uploaded and viewed in the reports sub-module that is preferably composed of upload report section and view report section.

According to first embodiment of the present invention, the upload report section is configured to upload, store and view the medical reports related to abnormalities, allergies, habits and work hazards, preventive health, childhood development, pregnancies and medical insurance of the individual user.

According to first embodiment of the present invention, the upload report section is composed of report of field, report relation field, report type field, report date field, report selection field and report upload field.

According to first embodiment of the present invention, the report of field of the upload report section is configured to select topics of abnormalities, allergies, habits and work hazards, pregnancies, preventive health, childhood development and medical insurance in each sub-module of the user interface module.

According to first embodiment of the present invention, the report relation field of the upload report section is configured to automatically select sub topics that are previously entered by the user relating to the topics selected in each sub-module of the user interface module.

According to first embodiment of the present invention, after selecting the sub topics in the report relation field, report type and date are selected in the respective report type and date fields of the upload report section, and reports are selected and uploaded in the respective report selection and upload fields of the upload report section.

According to first embodiment of the present invention, the reports uploaded in the upload report section are displayed and viewed in the doctor interface module based on report of, report type and period selected in the view report section of the report sub-module.

According to first embodiment of the present invention, the reports in the report sub-module are viewed based on the report of field, the report relation field, the report type field and the date of report.

According to first embodiment of the present invention, the information relating to allergies, habits and work hazards of the individual user are recorded in the allergies, habits and work hazards sub-module that is preferably composed of known allergies section and habits section.

According to first embodiment of the present invention, the known allergies section is configured to record identified allergens along with its reaction, response and the age at which the allergy was experienced by the individual user, which are displayed in a known allergies table in the user interface module and the doctor interface module.

According to first embodiment of the present invention, the habits section is configured to capture details of habits such as smoking, tobacco, alcohol and exercise of the individual user along with relevant details of quantity, duration, frequency and years, which are displayed in a habit table in the user interface module and the doctor interface module.

According to first embodiment of the present invention, the work hazards section is configured to capture details of work hazards (in professional as well as personal life) such as type of work/work hazard, how long (years) and effect of hazard on one's health which are displayed in a work hazards table in the user interface module and the doctor interface module.

According to first embodiment of the present invention, the information related to family health of the individual user is recorded in the family health sub-module that is preferably composed of family allergies section and family abnormalities section.

According to first embodiment of the present invention, the family allergies section is configured to record relationship and identified allergens along with its reaction and response of the family members of the individual user, which are displayed in a family allergies table in the user interface module and the doctor interface module.

According to first embodiment of the present invention, the family abnormalities section is configured to record relationship and identified abnormalities of the family members of the individual user, which are displayed in a family abnormalities table in the user interface module and the doctor interface module.

According to first embodiment of the present invention, the information related to preventive health plans and records are recorded in the preventive health sub-module that is preferably composed of year health planner section and template elements.

According to first embodiment of the present invention, the year health planner section is configured to prepare and record periodic preventive health plan covering details of parameter and health checks, frequency of check and period of check in year and month wise manner whereas the template elements is configured to record periodic details of health checks along with its test reports undergone by the individual user.

According to first embodiment of the present invention, the year health planner section is configured to generate auto reminder for the pending preventive health checks to the individual user based on the year health planner of the individual user.

According to first embodiment of the present invention, the information related to health records of childhood development of the individual user are recorded in the childhood development sub-module that is preferably composed of immunization section, physical development section and ability development section.

According to first embodiment of the present invention, the childhood development sub-module is configured to track and monitor the details of child development that is accessed and displayed in the form of tables in the user interface module.

According to first embodiment of the present invention, the immunization section is configured to prepare, record and track an immunization schedule of the child along with its country, recommended age, vaccines, notations, due date, given date and reactions, where due dates are automatically compiled from the account information and the details of immunization schedule are accessed and viewed in the user interface module.

According to first embodiment of the present invention, the immunization section is configured to generate auto reminder for the pending immunization to the individual user based on the immunization schedule.

According to first embodiment of the present invention, the ‘physical development’ section is configured to record and track child physical growth related to height, weight and head circumference along with its age and comments on growth, where the details of child physical growth are accessed and viewed in the user interface module.

According to first embodiment of the present invention, the ‘ability development’ section is configured to record and track child ability growth of motoring, vision, hearing, speaking, vocal, comprehension, tooth development, behavioral and social at different age groups, where the details of child abilities in the ability development section are accessed and viewed in the user interface module.

According to first embodiment of the present invention, the pregnancies sub-module is configured to generate and store comprehensive information related to pregnancies of the individual woman user, which preferably relates to a chronological list of pregnancies, pregnancy background and issues, prenatal consultation details, medical intervention details, test details, prescribed medicines and prenatal consultation history of the individual pregnancy.

According to first embodiment of the present invention, the pregnancies sub-module is preferably composed of pregnancies history section, prenatal consultation elements, medicines prescribed elements and prenatal consultation history elements.

According to first embodiment of the present invention, the details of age wise pregnancies of the individual woman user are recorded in the pregnancies history section for generating a chronological and comprehensive table of pregnancies in the user interface module.

According to first embodiment of the present invention, the pregnancies history section is preferably composed of fields of pregnancy conceived at age, special health condition, delivery type and notes on childbirth.

According to first embodiment of the present invention, the prenatal consultation elements are configured to record every prenatal consultation details of each of the pregnancies entered in pregnancies history section for generating a comprehensive table of prenatal consultation details of the pregnancies with pregnancy description.

According to first embodiment of the present invention, the prenatal consultation elements are preferably composed of fields of current health issues, missing requirements for physical and mental well-being of the woman user, hospital or patient reference number, doctor name, test taken, observation and diagnosis, medical intervention or procedure, medicines prescribed, doctor's advice, effectiveness of medicines or medical intervention and date of update.

According to first embodiment of the present invention, the medicines prescribed elements are configured to record details of medicines prescribed during each consultation entered in the prenatal consultation details and preferably composed of fields of medicine and strength, dosage unit, with respect to food, morning, noon, night, anytime of the day, and number of days, along with abnormality description, doctor name and date of consulting.

According to first embodiment of the present invention, the prenatal consultation history elements are automatically generated for each pregnancy by collating information from details entered in the prenatal consultation elements and the medicines prescribed elements, which provides chronological details of the consultation and medical intervention of the pregnancy.

According to first embodiment of the present invention, the information related to medical insurance and claim details of the individual user are recorded and maintained in the medical insurance sub-module.

According to first embodiment of the present invention, the information about medical insurance preferably include insurance company name, policy number, secondary number, policy coverage amount, premium amount, policy begin date, policy end date, contact details, and link to claims and payment receipt.

According to first embodiment of the present invention, the information about claim details preferably include claim reason, name of hospital or lab or pharmacy, receipt number, date, amount, payment receipt and comments.

According to first embodiment of the present invention, the medical insurance sub-module is configured to generate auto reminder for non-coverage of insurance or current insurance coverage details, which is displayed to the individual user in the user interface module.

According to first embodiment of the present invention, the information related to user account is recorded and maintained in the manage account sub-module.

According to first embodiment of the present invention, the manage account sub-module is preferably composed of an account information section to allow the user to modify, edit and change any account related details about the user, and a change password section to allow the user to change the password.

According to first embodiment of the present invention, the user account information section is registered with details that preferably includes user name, first name, last name, gender, date of birth, address, city, zip or pin code, country, email identification, home phone number, mobile phone number, blood group and security password question.

According to first embodiment of the present invention, the change password section is registered with password details that preferably includes user name, new password and confirm new password.

According to first embodiment of the present invention, the doctor interface module is preferably segmented into abnormalities sub-module, reports sub-module, allergies, habits and work hazards sub-module, family health sub-module and pregnancies sub-module for retrieving and displaying the respective health information and reports of the individual user recorded in the respective sub-modules of the user interface module.

According to first embodiment of the present invention, the comprehensive health information recorded in each of the abnormalities sub-module, the reports sub-module, the allergies, habits and work hazards sub-module, the family health sub-module and the pregnancies sub-module of the user interface module are automatically exported and accessed in the doctor interface module.

According to second embodiment of the present invention, which achieves the objectives, relates to a method for sharing and searching user experience with symptoms and medical intervention details in an integrated system of Electronic Medical Records for Individuals (EMRI) module and Patient Information Exchange (PIE) module. The method comprises the steps of acquiring and recognizing ‘My experiences with symptoms’ by an individual user in a share sub-module of the PIE module through a user interface. Applicability and usefulness of sharing of the user's ‘My experiences with symptoms’ are determined, and the user's ‘My experiences with symptoms’ are recorded in the share sub-module. The user's ‘My experiences with symptoms’ are stratified and stored in a coder and database storage device. Cases of ‘My experiences with symptoms’ is searched for specific symptoms and identified from the coder and database storage device based on a search criteria selected and entered in a search sub-module of the PIE module. A list of users' My experiences with symptoms' is displayed from the share sub-module that matches with the search criteria entered in the search sub-module. A specific user's ‘My experiences with symptoms’ is then selected for viewing of the details of user experiences from the coder and database storage device. Thus, such method facilitates easy public sharing of the user's ‘My experiences with symptoms’. It also achieves effective diagnosis and determination of right course of medical intervention to enhance the quality of life and mitigating trauma for the user.

According to second embodiment of the present invention, the share sub-module and the search sub-module are connected to the coder and database storage device for sharing and searching experiences of ‘My experiences with symptoms’ of the individual user with the coder and database storage device.

According to second embodiment of the present invention, the share sub-module is preferably composed of a profile section, symptom experienced section, diagnosis and medical intervention section and lessons learnt from the experience section for recording information related to the ‘My experiences with symptoms’ undergone by the individual user.

According to second embodiment of the present invention, in the share sub-module, the method further comprises the steps of recording information related to user profile based on fields defined by the profile section. Information related to symptoms experienced by the individual user is selected and recorded based on fields defined by the symptom experienced section. Information related to the ‘My experiences with symptoms’ undergone for the symptoms experienced by the individual user, is recorded based on fields defined by the diagnosis and medical intervention section and the lessons learnt from the experience section. The cases of ‘My experiences with symptoms’ by the individual user along with the user profile are shared, stratified and stored in the coder and database storage device.

According to second embodiment of the present invention, the fields of the profile section preferably include age group, gender, period (when diagnosed), country of residence, ZIP/PIN code, natural subgroup, and mail identification.

According to second embodiment of the present invention, the fields of the symptom experienced section include body region field which preferably includes head and neck region, upper limb region, chest region (Thorax), middle region, back region, pelvis region, lower limb region and other body region, from which a specific body part of the body region is selected from another field and then the symptom associated with that body part is selected from yet another field.

According to second embodiment of the present invention, the fields of the diagnosis and medical intervention section preferably include abnormality diagnosed, tests and results to confirm diagnosis, possible causes, medical intervention, effectiveness of medical intervention, and learning from the experience.

According to second embodiment of the present invention, the fields of the lessons learnt from the experience section preferably include user awareness of the symptoms in the early stages, earliest form of symptoms experienced, symptom(s) level at which medical intervention was sought, time delay by the user in seeking medical intervention, precaution/steps that may have helped avoid the abnormality/mitigate the trauma and tangible benefits of timely medical intervention etc.

According to second embodiment of the present invention, the information recorded in the profile section, the symptom experienced section, the diagnosis and medical intervention section and the lessons learnt from experience section are previewed and edited in the share sub-module before sharing the experiences of symptoms and medical intervention details.

According to second embodiment of the present invention, the search sub-module is preferably composed of a profile section for entering search criteria related to patient profile, and a symptom experienced section for selecting and entering search criteria related to the symptoms experienced by the individual user.

According to second embodiment of the present invention, in the search sub-module, the method further comprises the steps of recording information related to user profile based on search criteria fields defined by the profile section. Information related to symptoms experienced by the individual user is selected and recorded based on search criteria fields defined by the symptom experienced section. A list of users' shared cases of ‘My experiences with symptoms’ are displayed from the share sub-module that matches with the search criteria selected in the search sub-module. The specific case of ‘My experiences with symptoms’ is then identified and selected from the coder and database storage device with respect to the search criteria, selected in the fields of the profile section and the symptom experienced section.

According to second embodiment of the present invention, the search sub-module is preferably composed of a profile section, a symptom experienced section for searching of shared eases related to the ‘My experiences with symptoms’.

According to second embodiment of the present invention, the fields of the profile section preferably include age group, gender, time period, country of residence and natural sub group.

According to second embodiment of the present invention, the fields of the symptom experienced section include body region field which preferably includes head and neck region, upper limb region, chest region (Thorax), middle region, back region, pelvis region, lower limb region and other body region, from which a specific body part of the body region is selected from another field and then the symptom associated with that body part is selected from yet another field.

According to second embodiment of the present invention, the information recorded in the profile section and the symptom experienced section are previewed and edited in the search sub-module before searching for the user experiences of symptoms and medical intervention.

According to second embodiment of the present invention, the search sub-module displays a list of shared user experiences of symptoms and medical intervention details along with reference numbers from the coder and database storage device based on the search criteria entered in it.

According to second embodiment of the present invention, the details of the selected case are accessed and displayed from the displayed list of shared user experiences of symptoms and medical intervention details in the search sub-module.

According to second embodiment of the present invention, the search sub-module of the PIE module aids the user to structure and organize the health information and reports in each sub-module in the EMRI module while creating and recording the medical information of the individual user in the EMRI module.

In order to have a further understanding of above features and advantages of the present invention, a detailed description is given below with embodiments and accompanying drawings.

### BRIEF DESCRIPTION OF THE DRAWINGS

These and other objects, features and advantages of the present invention will be further apparent from the following description taken in conjunction with the several figures of the accompanying drawings which show, by way of example only one form of this present invention. The invention will be discussed in greater detail with reference to the accompanying drawings.

FIG. 1 illustrates an overall block diagram of an integrated system of Electronic Medical Records for Individuals (EMRI) module and Patient Information Exchange (PIE) module, in accordance with an exemplary embodiment of the present invention;

FIG. 2 illustrates a detailed block diagram of the EMRI module of the integrated system, in accordance with an exemplary embodiment of the present invention;

FIG. 3 illustrates a block diagram of a user module of the integrated system, in accordance with an exemplary embodiment of the present invention;

FIG. 4 illustrates a block diagram of a doctor module of the integrated system, in accordance with an exemplary embodiment of the present invention;

FIG. 5 illustrates a block diagram of an abnormalities sub-module of the user module, in accordance with an exemplary embodiment of the present invention;

FIG. 6 illustrates a flowchart depicting a functional process of the abnormalities sub-module of the user module, in accordance with an exemplary embodiment of the present invention;

FIG. 7 illustrates a flowchart depicting a functional process of reports sub-module of the user module, in accordance with an exemplary embodiment of the present invention;

FIG. 8 illustrates a flowchart depicting a functional process of allergies, habits and work hazards sub-module of the user module, in accordance with an exemplary embodiment of the present invention;

FIG. 9 illustrates a flowchart depicting a functional process of family health sub-module of the user module, in accordance with an exemplary embodiment of the present invention;

FIG. 10 illustrates a flowchart depicting a functional process of preventive health sub-module of the user module, in accordance with an exemplary embodiment of the present invention;

FIG. 11 illustrates a block diagram of a childhood development sub-module of the user module, in accordance with an exemplary embodiment of the present invention;

FIG. 12 illustrates a flowchart depicting a functional process of immunization section of the childhood development sub-module of the user module, in accordance with an exemplary embodiment of the present invention;

FIG. 13 illustrates a flowchart depicting a functional process of physical development section of the childhood development sub-module of the user module, in accordance with an exemplary embodiment of the present invention;

FIG. 14 illustrates a flowchart depicting a functional process of ability development section of the childhood development sub-module of the user module, in accordance with an exemplary embodiment of the present invention;

FIG. 15 illustrates a block diagram of a pregnancies sub-module of the user module, in accordance with an exemplary embodiment of the present invention;

FIG. 16 illustrates a flowchart depicting a functional process of the pregnancies sub-module of the user module, in accordance with an exemplary embodiment of the present invention;

FIG. 17 illustrates a flowchart depicting a functional process of medical insurance sub-module of the user module, in accordance with an exemplary embodiment of the present invention;

FIG. 18 illustrates a detailed block diagram of the doctor module, in accordance with an exemplary embodiment of the present invention;

FIG. 19 illustrates a block diagram of the PIE module of the integrated system, in accordance with an exemplary embodiment of the present invention;

FIG. 20 illustrates a detailed block diagram of the PIE module of FIG. 19, in accordance with an exemplary embodiment of the present invention;

FIG. 21 illustrates a flowchart depicting a functional process of a share sub-module of the PIE module, in accordance with an exemplary embodiment of the present invention; and

FIG. 22 illustrates a flowchart depicting a functional process of a search sub-module of the PIE module, in accordance with an exemplary embodiment of the present invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention for the purpose of clear understanding and by the way of any limitations.

The present invention relates to a simple integrated system of ‘Electronic Medical Record for Individuals’ (EMRI) and ‘Patient Information Exchange (PIE) to perform a method for creating and recording medical information of a user (patient) and for sharing user ‘experiential learning with symptoms and related medical intervention’, which is capable of enhancing the quality of life and mitigating trauma for some other user. The present invention facilitates easy availability of comprehensive and chronological medical records or health information of the user as well as facilitates easy public sharing of ‘experiential learning with symptoms and related medical intervention’ (‘My experiences with symptoms’) of the user. Thus, the present invention provides relevant, comprehensive and chronological inputs for effective diagnosis by the doctors and determination of right course of medical intervention for the patients, thereby enhancing the quality of life and mitigating trauma for the patients. It also minimizes the information gap between the patients and the doctors for effective diagnosis.

Further, the present invention aids in quick diagnosis of abnormality or causes correctly and recommendation of correct medical intervention in the shortest possible time. In particular, the EMRI module of this present system provides the comprehensive, chronological and well linked ‘Medical information or record’ for effective diagnosis and determination of right course of medical intervention. Whereas, the PIE module of this present system provides a single platform (web based platform) for sharing of patient's ‘My experiences with symptoms’ outlining the learning from the entire ‘Medical intervention journey’, {ie the learning from symptom(s) identification, recognition of the uniqueness of the symptom(s), consultation with doctor(s), undergoing appropriate observation/test(s) & diagnosis by doctor(s), medical intervention, corrective/preventive steps to be undertaken by the patient for trauma mitigation/avoidance/recovery as suggested by doctor and/or from self analysis of what went wrong with the trauma episode etc, where the sharing of such hands on learning and presenting of the experiences in a structured and systematic manner facilitates the user in understanding the importance of types of symptoms, their uniqueness and appropriate preventive/corrective measures for seeking early medical intervention/simple preventive, corrective care etc and help avoid/mitigate potential trauma (if any) and associated costs/resources. Such inputs and related understanding also helps in enhancing the user's preparedness to provide comprehensive and chronological information to describe symptoms in a clear manner to his/her doctors during consultation.

The information collated from the database of shared experiences in dealing with symptoms provide for many areas of improvements that benefits the society at large, such as targeted medical attention for specific ‘Gender/Age groups/Countries/Areas/Natural sub groups/Medical research purposes/Teaching purposes/Drug, Medicine development purposes/Insurance purposes/Enhancing knowledge level about symptoms and their uniqueness/Standardizing symptom(s) description etc

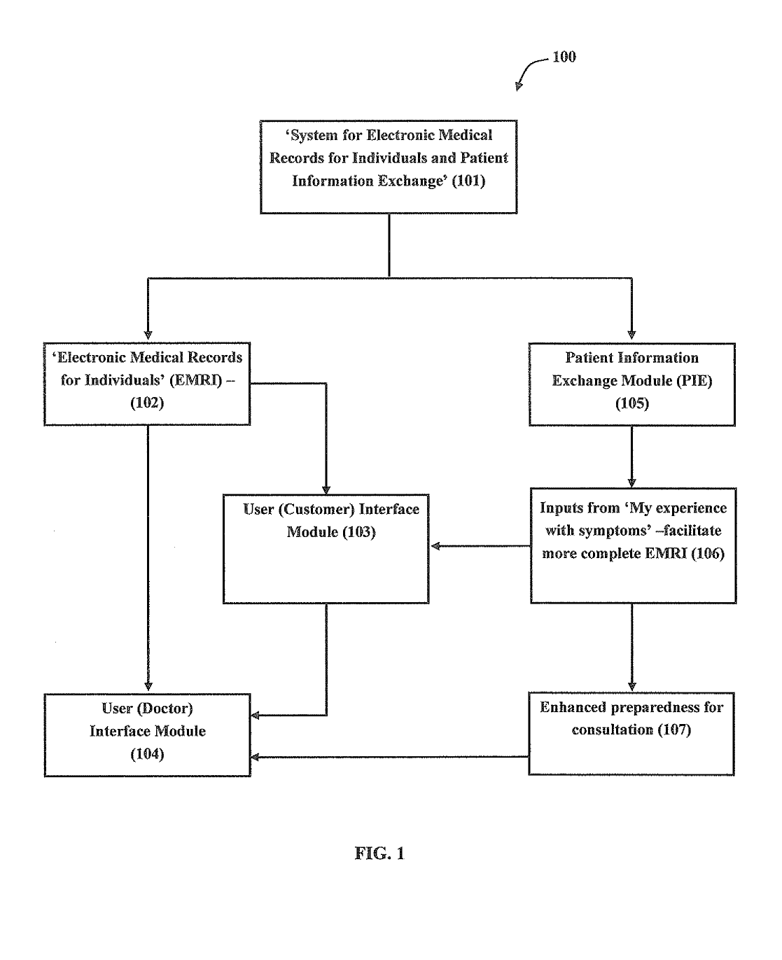

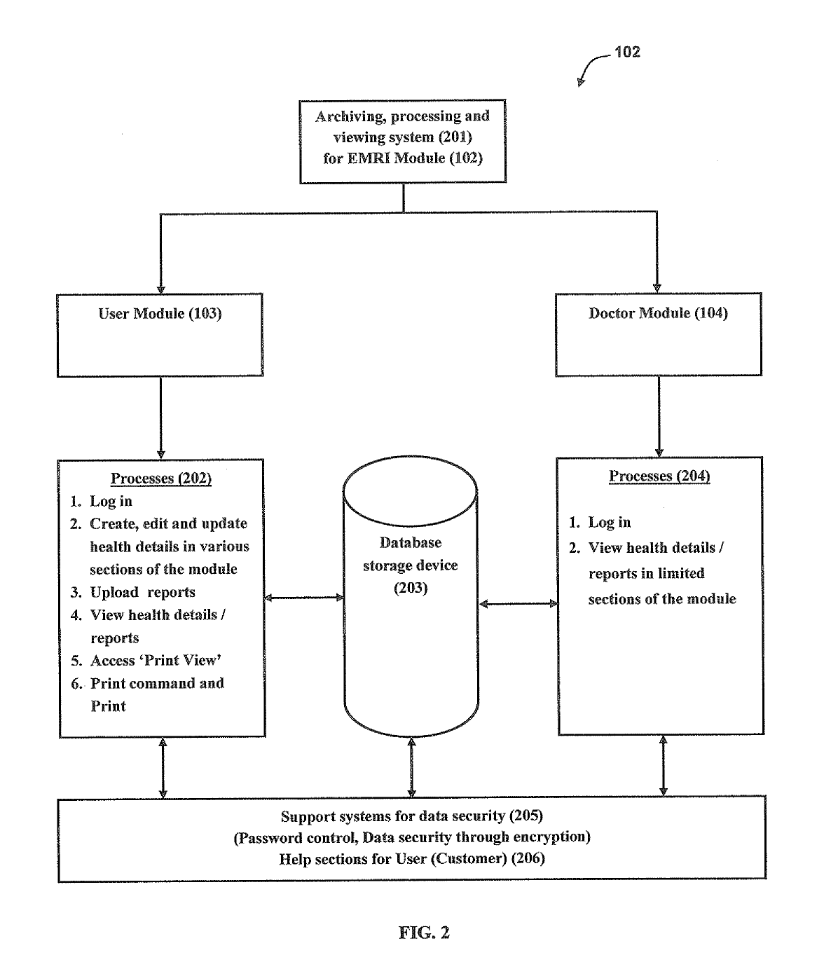

FIG. 1 illustrates an overall block diagram of an integrated system (101) of Electronic Medical Records for Individuals (EMRI) module (102) and Patient Information Exchange (PIE) module (105), in accordance with an exemplary embodiment of the present invention. The present system is preferably composed of two modules such as EMRI module (102) and PIE module (105), where the EMRI module (102) and the PIE module (105) are preferably designed to be web-based modules. Firstly, the EMRI module (102) contains all medical and health information pertaining to the individual user (patient), which is clearly described in FIGS. 2 to 18. The EMRI module (102) is configured to maintain comprehensive and chronological health information and reports of the individual user (patient) and to record/provide vital macro and micro health information.

The EMRI module (102) is composed of User (Customer) Interface Module (103) and User (Doctor) Interface Module (104), where these modules (103, 104) are henceforth referred as ‘User Module’ and ‘Doctor Module’ respectively only for the purpose of understanding. The doctor module (104) of the EMRI module (102) is coupled with the user module (103) to receive medical information and reports from the user module (103). The user module (103) is dedicated to maintain health information preferably covering details related to abnormalities, reports, allergies, habits and work hazards, family health, preventive health, childhood development, pregnancies, etc of each of the individual users. Whereas the doctor module (104) provides access to the doctor or authorized user for viewing comprehensive and factual health information of the patients in order to facilitate effective diagnosis and correct medical intervention. The user module (103) and the doctor module (104) are linked together for quick access to relevant macro and micro information. The user module (103) and the doctor module (104) of the EMRI module (102) are designed to be more than a storehouse of medical reports/records. The user module (103) in particular serves as a complete repository of the user (patient) medical/health information and reports of/for life. The EMRI module (102) also displays automatic reminders for pending health related activities on log-in.

The EMRI module (102) is embedded with all available gadgets and connectivity as well as web-based connectivity to greatly benefit the individuals and the doctors. The EMRI module (102) facilitates preparation of well documented, chronological and well linked medical information and reports, which leaves practically nothing to the patient's memory and provides quick vertical and horizontal linkages. The EMRI module (102) helps in enhancing quality and content of communication with the doctors to facilitate effective and faster diagnosis and also helps to easily maintain preventive health planning and maintaining records through appropriate preventive healthcare that facilitates better upkeep of health which is needed as a result of increased life expectancy. Thus, it minimizes dependence on others as well as overall medical cost for the user.

The EMRI module (102) helps to monitor growth and development of physical and other abilities by allowing the user to track immunization and childhood development attributes in a time-bound manner. The EMRI module (102) helps women users to maintain records of all pregnancies and periodic prenatal reviews (consultation) leading to safe delivery and child birth. The EMRI module (102) also generates and displays automatic reminders on pending health information such as pending immunization, preventive checks, insurance etc. The EMRI module (102) exports key outputs from the user module (103) to the doctor module (104) to make available only pertinent data for diagnosis, which avoids volumes of irrelevant health data and information to a particular consulting. It is designed to be friendly to both the end users and the doctors with inbuilt data security through password control and data encryption, as well as to provide maximum information with minimal effort for preparation and updation.

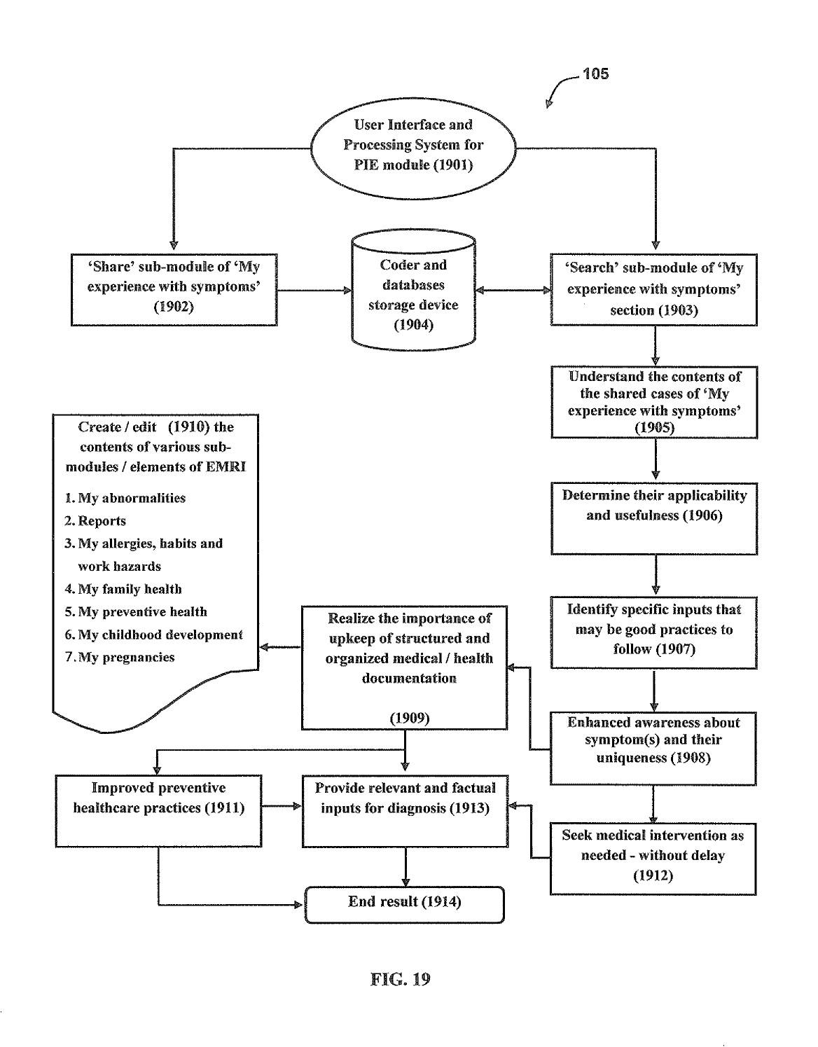

Secondly, the PIE module (105) is designed to allow the user to access for sharing and searching of medical and health experiential learning with symptoms, which is clearly described in FIGS. 19 to 22. In particular, the user can retrieve inputs and information from experience with symptoms shared through the PIE module (105) and identify specific useful inputs (106) from the cases of ‘My experiences with symptoms's’ shared through the PIE module (105). The identified inputs (106) from the cases of ‘My experiences with symptoms’ shared through the PIE module (105) can help the user in self-analysis of enhanced preparedness for consultation (107), where the user self-analysis can lead to possible benefits such as enhanced awareness about symptoms, understand uniqueness of symptoms, focus on preventive healthcare, recognize importance of upkeep of medical documentation, and desire/urge to seek early medical intervention. Preferably, the identified inputs (106) and the enhanced preparedness for consultation (107) are respectively coupled to the user module (103) and the doctor module (104) to update medical documentation in the user module (103) and the doctor module (104), which results in enhanced quality of health and improved inputs for ability to present holistic data, doctor more informed about patient's health background, trauma mitigation or avoidance and lower cost of upkeep of health.

The PIE module (105) of the integrated system (101) is configured to capture patient's experiential learning from medical intervention journey {ie the learning from symptom(s) identification, recognition of the uniqueness of the symptom(s), consultation with doctor(s), undergoing appropriate observation/test(s) & diagnosis by doctor(s), medical intervention, corrective/preventive steps to be undertaken by the patient for trauma mitigation/avoidance/recovery etc as suggested by doctor and/or from self analysis of what went wrong with the trauma episode). Such learning from the diagnosis and medical intervention journey makes the patients to be more informed with certain preventive and corrective practices, which can help in prevention of occurrence/recurrence of the diagnosed abnormality or trauma mitigation for the user or another user, where the patient's experiential learning can herein be referred as ‘My experiences with symptoms’ only for the purpose of understanding. The PIE module (105) provides a platform for sharing of patient's ‘experiential learning with symptoms and related medical intervention’ including medical intervention details either in private domain for the benefit to the known persons or in public domain for the larger benefit of the society. The PIE module (105) retrieves and visualizes matching cases of ‘My experiences with symptoms’ based on search criteria selected or inputted by the user, where the information from shared cases of the PIE module (105) is neither intended to be medical advice nor an input for self-medication.

Further, the PIE module (105) is designed to record and share the user's traumatic and expensive experiences in public domain, which leads to trauma avoidance and mitigation besides saving valuable resources and agony for those associated with the patients. This PIE module (105) also make easier for the doctor to provide early consulting for improving the possibility of success rate of medical intervention. The PIE module (105) stratifies and stores cases of shared ‘My experiences with symptoms’ based on several criteria and facilitates their searching and viewing with easy, simple fields and templates. The PIE module (105) is built around the symptoms described in a common understandable language.

More specifically, in this integrated system, the EMRI module (102) stores and maintains lifetime health information and reports of the individual user to serve comprehensive and well-linked medical documentation, factual information to doctors for diagnosis and focus on holistic healthcare of the user. The PIE module (105) acts as a user-friendly repository of shared learning of the patients from their medical intervention journey. The PIE module (105) is built around symptoms and body parts combination, stratified and coded, which makes available shared cases to the public based on search criteria. The NE module (105) helps to enhance the contents of the EMRI module (102), which work together to maintain good quality health of the individual user and avoid or mitigate trauma of the general public.

FIG. 2 illustrates a detailed block diagram of the EMRI module (102) of the integrated system (101), in accordance with an exemplary embodiment of the present invention. The EMRI module (102) facilitates data entry and storage of medical and health information and reports during leisure time. There can be ample opportunities to consult family members for seeking additional information that they are willing to share in the process of creation of the EMRI module (102) for the individual user. The medical and health information of the individual user can be continually updated through the EMRI module (102). The EMRI module (102) allows entering of details in fields of its various sub-modules, sections and elements to ensure that the individual is able to prepare a comprehensive, chronological and well linked medical information and record, where all the sub-modules, sections and elements are designed to be user and doctor friendly and easy to use. Help link is provided in each of these sub-modules, sections and elements to guide the individual user. Initially, User ID is created for every individual account, where all the data entered and uploaded reports are stored in a database storage device (203). The individual user can update the data at any time and can choose to share the ‘User ID’ and ‘Password’ if deemed necessary for handling any emergency. The EMRI module (102) is conceived to be ‘web based’ data storage and retrieval system for the users.

The EMRI module (102) is used as a gateway of archiving, processing and viewing system (201) for the user module (103) and the doctor module (104), where the user module (103) and the doctor module (104) are connected to a database storage device (203) that stores health data and information. The user module (103) is an interactive model that is interconnected with a database storage device (203), which allows the user to execute processes as defined in step (202). The database storage device (203) stores all the data created, edited, updated and saved by the user, which is available in the user module (103). The authorized user initially can log-in to the user module (103) to create, edit and update health details in various sub-modules, sections and elements, to save reports, to view health information and reports as well as to access print view and use print command and print. The log-in authentication of the user can be verified with the help of support system for data security (205) that can provide data security through password control and encryption along with help section (206).

Additionally, help section (206) is provided for each sub-modules of the user module (103), where the user has access to all the sub-modules, sections and elements in the user module′ (103). Pertinent outputs from the user module (103) are exported to the doctor module (104) for viewing purposes, i.e. outputs from selected sub-modules, sections and elements of the user module (103) pertinent for diagnosis are exported to the doctor module (104). The outputs of these selected sub-modules of the user module (103) are accessed in the doctor module (104) through which the doctor can execute processes as defined in step (204), i.e. by accessing the doctor module (104) after log-in, for viewing the health details and reports in the selected sub-modules of the user module (103) for the diagnosis and medical intervention. The selected health details and reports can be part of the sub-modules of abnormalities, reports, allergies, habits and work hazards an family health and pregnancies and the sections & elements of theses sub-modules. The EMRI module (102) automatically includes the pregnancies sub-module, when the gender is marked as ‘Female’ while creating the account. In particular, the user can have access to all sub-modules, sections and elements of the user module (103) for data entry, updation and viewing. In the doctor module (104), the user can have access only to view outputs from limited sub-modules, sections and elements of the user module (103) for diagnosis purposes.

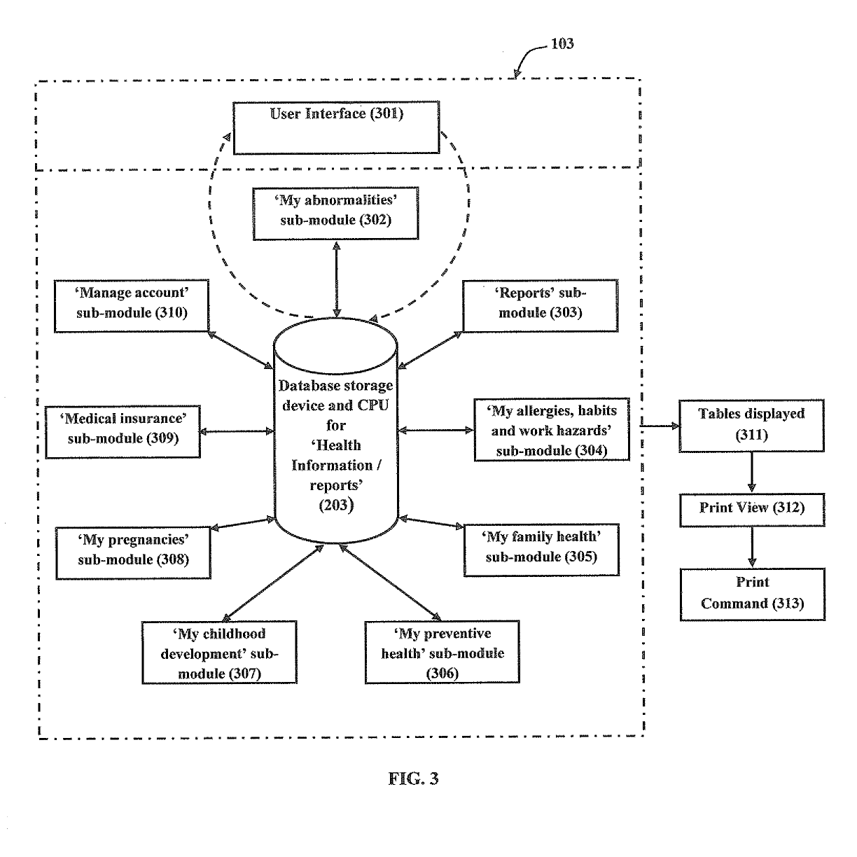

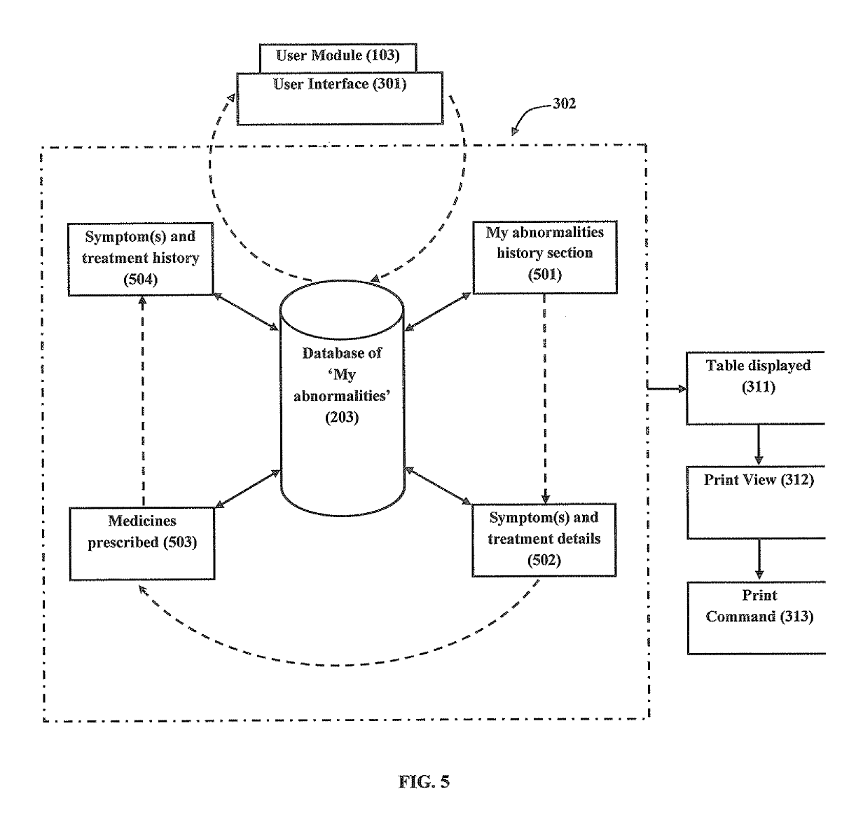

FIG. 3 illustrates a block diagram of the user module (103) of the integrated system, in accordance with an exemplary embodiment of the present invention. The user module (103) is configured for creating, updating, editing, saving and printing of stored health information and reports of the individual user, besides the facility to viewing the contents. The user module (103) is operated by the user through a user interface (301) such as touch screen, keyboard and pointing device, for accessing the information stored in the storage device (203) and printer (not shown) in an interactive manner. The user module (103) is subdivided and segmented into various sub-modules to cover all pertinent health information requirements for the individual user. The user module (103) is preferably segmented into abnormalities sub-module (302), reports sub-module (303), allergies, habits and work hazards sub-module (304), family health sub-module (305), preventive health sub-module (306), childhood development sub-module (307), pregnancies sub-module (308) (for females), medical insurance sub-module (309) and manage account sub-module (310), where all the sub-modules (302-310) are directly connected to the database storage device (203) for health information and reports. The pregnancies sub-module (308) is segmented in the user module (103) only when the gender is marked as ‘Female’ at the time of creating a new account in the EMRI module (102). The outputs of the sub-modules (302-310) of the user module (103) are displayed in table (311) and provided in a print view form (312) and print facility (313), where the sub-modules (302-310) of the user module (103) are clearly explained in detail in FIGS. 5 to 17.

The user module (103) begins with the abnormalities sub-module (302) that is configured for quick presentation of a chronological list (age wise list) of abnormalities of the individual user from childhood. In particular, this abnormalities sub-module (302) is stored with the comprehensive, chronological and well linked information preferably about abnormality background, symptoms, consultation and treatment details, test reports, prescribed medicines, case history, etc., of the individual user. This sub-module (302) is preferably composed of abnormalities history section and elements of symptoms and treatment details, medicines prescribed and symptoms and treatment history. The outputs of this abnormalities sub-module (302) are exported to the doctor module (104), which helps the doctor to get a quick overview as well as complete case details of the individual user. The report sub-module (303) is configured for storing and viewing medical reports, where this sub-module (303) is preferably composed of upload report section and view report section. The allergies, habits and work hazards sub-module (304) is configured for recording information relating to allergies, habits and work hazards of the individual user, where this sub-module (304) is preferably composed of known allergies section, habits section and work hazards section. The family health sub-module (305) is configured for recording health information of the blood relatives of the user, where this sub-module (305) is preferably composed of family allergies section and family abnormalities section. The outputs of the allergies, habits and work hazards sub-module (304) and family health sub-module (305) besides the reports uploaded in the report sub-module (303) are also exported to the doctor module (104) which can be accessed from the same.

The preventive health sub-module (306) is configured for recording preventive health plans and records, where this sub-module (306) is preferably composed of section of year health planner for parameter & health checks and template elements for various health checks. The childhood development sub-module (307) is configured for recording health records of childhood development (preferably up to the age of 5 years for development and upto 16 years for immunization), where this sub-module (307) is preferably composed of immunization section, physical development section and ability development section. The pregnancies sub-module (308) is configured for recording details related to pregnancy background and issues, prenatal consultation and medical intervention details, test reports, prescribed medicines and prenatal consultation history of the female user. This sub-module (308) is preferably composed of pregnancies history section and elements of prenatal consultation details, medicines prescribed and prenatal consultation history. The pregnancies sub-module (308) is segmented in the user module (103) only when the gender is marked as ‘Female’ at the time of creating a new account in the EWIR1 module (102). The outputs of this abnormalities sub-module (308) are exported to the doctor module (104), which helps the doctor to get a quick overview as well as complete pregnancy details of the female user.

The medical insurance sub-module (309) is a user supporting sub-module configured for recording insurance and claim details of the user in order to support the user to maintain details of insurance taken and claims made & payment received. Similarly, the manage account sub-module (310) is also another user supporting sub-module configured for recording ‘account details’ about the individual user. This sub-module (310) is preferably composed of an account information section to allow the user to modify, edit and change any account related details about the user, and a change password section to allow the user to change the password. Initially, account information is entered and registered in the account information section, where the account information preferably includes user name, first name, last name, gender, date of birth, user name, password, confirm password, address, city, zip or pin code, country, email identification, confirm email identification, home phone number, mobile phone number, blood group, security password question, etc. Then, the password details are entered and registered in the change password section, where the password details includes user name, new password, confirm new password, etc. The account information and password details in the manage account sub-module (310) are saved and updated in the database storage device (203) of the EMRI module (102). Such account information and password details in the manage account sub-module (310) are accessed, viewed and edited or modified by the user through the user interface (301) in the user module (103). Once all the information and details are entered and updated in all these sub-modules (302-310) of the user module (103), then the sub-modules (302-310) allow the user to generate tables (311) as well as to access print view (312) and print command (313).

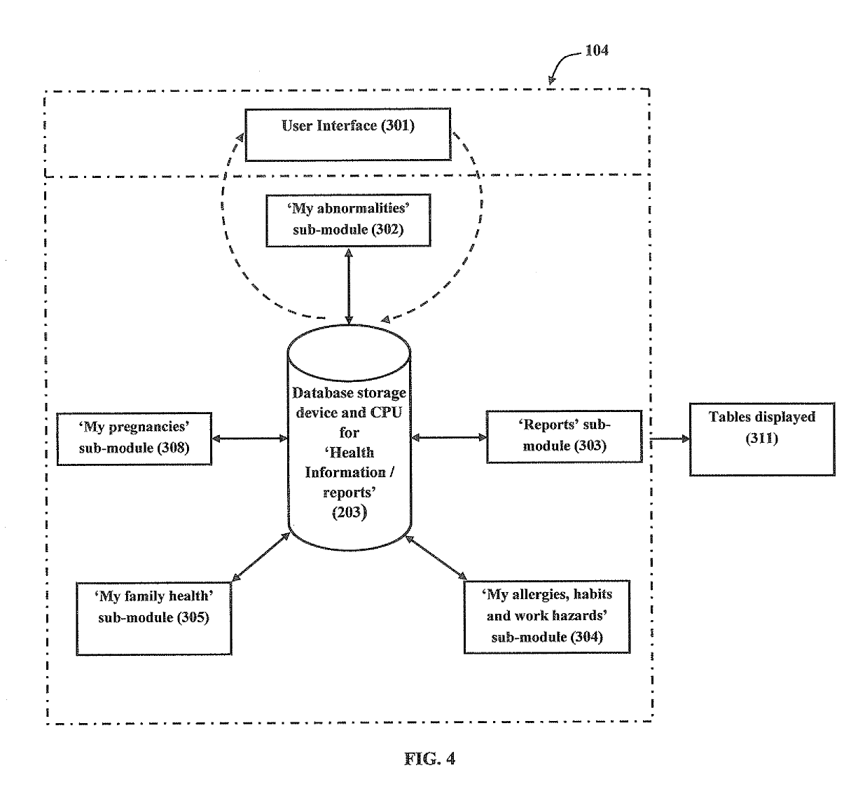

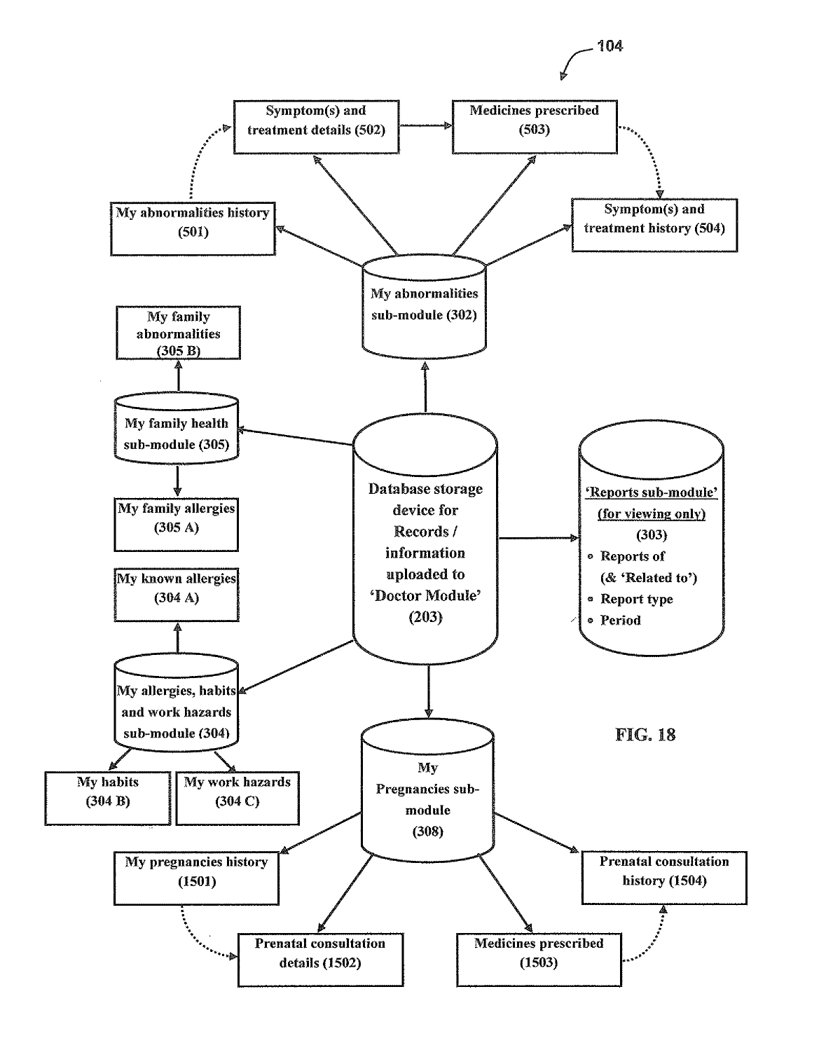

FIG. 4 illustrates a block diagram of the doctor module (104) of the integrated system (101), in accordance with an exemplary embodiment of the present invention. The doctor module (104) is interfaced with the user module (103) and is operated by the user through the user interface (301) for viewing health information and reports stored in the database storage device (203), in an external environment such as doctor's clinic or office for the effective diagnosis. The health information and reports created and stored in the storage device (203) using the user module (103) are viewed in the doctor module (104). This doctor module (104) is configured for viewing health information and reports only, and thus it is not possible to create, update, edit and save medical reports and health information of the individual user in this doctor module (104). The doctor module (104) is subdivided and segmented into various sub-modules to cover and view all the user health information required by the doctor for effective diagnosis. The doctor module (104) is preferably segmented into abnormalities sub-module (302), reports sub-module (303), allergies, habits and work hazards sub-module (304), family health sub-module (305) and pregnancies sub-module (308) (for females), where all the sub-modules (302-305, 308) are exported from the user module (103) through the database storage device (203) for retrieval of health information and reports of the user created through the user module (103). The pregnancies sub-module (308) is segmented in the doctor module (104) only when the gender is marked as ‘Female’ at the time of creating a new account in the EMRI module (102). These sub-modules (302-305, 308) of the doctor module (104) are displayed in table (311), where these sub-modules (302-305, 308) of the doctor module (104) are clearly explained in detail in FIG. 18.

The health information (such as abnormalities history, symptoms and treatment details, medicines prescribed, symptoms and treatment history etc) viewed in the abnormalities sub-module (302) in the doctor module (104) are exported from the abnormalities sub-module (302) defined in the user module (103). The abnormalities sub-module (302) is configured for viewing of a chronological list (age wise list) of abnormalities of the individual user from childhood that is well linked with the elements of symptoms and treatment details, medicines prescribed and symptoms and treatment history. All the medical reports viewed in the reports sub-module (303) in the doctor module (104) are exported from the medical reports uploaded in the reports sub-module (303) of the user module (103). The health information of allergies, habits and work hazards viewed in the allergies, habits and work hazards sub-module (304) in the doctor module (104) are exported from the allergies, habits and work hazards sub-module (304) of the user module (103). The health information of user's family (blood relatives) allergies and abnormalities viewed in the family health sub-module (305) in the doctor module (104) are exported from the family health sub-module (305) of the user module (103). The health information (such as pregnancies history, prenatal consultation details, medicines prescribed, prenatal consultation history, etc) viewed in the pregnancies sub-module (308) in the doctor module (104) are exported from the pregnancies sub-module (308) of the user module (103). This pregnancies sub-module (308) is configured for viewing a comprehensive, chronological and well linked pregnancy background and issues, i.e. all important medical reports and information of the pregnant women.

FIG. 5 illustrates a block diagram of the abnormalities sub-module (302) of the user module (103), in accordance with an exemplary embodiment of the present invention. The abnormalities sub-module (302) is well linked and composed of abnormalities history section (501), symptoms and treatment detail elements (502), medicines prescribed elements (503) and symptoms and treatment history elements (504).

The abnormalities history section (501), symptoms and treatment details elements (502), medicines prescribed elements (503) and symptoms and treatment history elements (504), of the abnormalities sub-module (302) are connected and linked to the database storage device (203), where the abnormalities details in the abnormalities sub-module (302) can be accessed through the user interface (301) of the user module (103).

The information generated from the abnormalities history section (501) is a simple table providing individual's abnormality details from birth and providing quick connectivity to other elements of the abnormalities sub-module (302) in a well linked manner. The abnormalities history section (501) is preferably composed of fields of abnormalities and age. The abnormalities sub-module (302) is also provided with the help section (206) that lists categories of abnormalities that need to be considered while entering/updating details in this section.

The symptoms and treatment details elements (502) provides details of each consultation for a specific abnormality. The symptoms and treatment details elements (502) is configured to record every consultation details of each of the abnormalities entered in abnormalities history section (501) and is preferably composed of fields of current symptoms/issues, exposure to undesirable conditions, hospital, hospital/patient reference number, doctor name, test taken, observation and diagnosis, medical intervention or procedure, medicines prescribed, doctor's advice, effectiveness of medicines or medical intervention, date of update, etc.

Some of the fields of the symptoms and treatment details elements (502) are completed prior to consultation and the rest after consultation, where the initial fields can provide vital details of the patient's current symptoms, their uniqueness and issues, environmental exposure etc with the complete details of the past consulting. This way, the patient is benefited by providing all current, pertinent and past information to the doctor. The user module (103) of the EMRI module (102) provides for updation in the symptoms and treatment details elements (502) post consultation, covering many subjects including doctor (consulted), tests taken, observation & diagnosis, medicines prescribed, medical intervention or procedure, doctor's advice, effectiveness of medicines/medical intervention, updated on date etc.

The medicines prescribed elements (503) are preferably composed of fields of medicine and strength, dosage unit, with respect to food (eg. before or after food), morning (quantity), noon (quantity), night (quantity), anytime of the day (quantity), for number of days, etc. The essence of symptoms and treatment details elements (502) and medicines prescribed elements (503) are automatically summarized as the symptoms and treatment history elements (504).

When the fields for the abnormalities history section (501) are entered and completed, a table listing chronological details of the abnormalities suffered by the individual user is displayed under the heading of ‘My abnormalities history’. On selecting any abnormality from this table (My abnormalities history), the fields of the symptoms and treatment details elements (502) are available for entering or updation of details for the selected abnormality (such as diabetes). When the fields for the symptoms and treatment details elements (502) are completed, a table is generated under the heading ‘Symptoms and treatment details’ with the updated on date (date of consultancy), wherein the fields of the ‘medicines prescribed’ elements (503) are available for entering details of medicines prescribed on the updated date (date of consultancy) for the specific abnormality.

For example, when the fields of ‘Symptoms and treatment details’ elements (502) are entered/updated, a table is generated with heading as ‘My abnormalities history>>Diabetes>>Symptoms and treatment details’ (if the details to be entered or updated pertain to Diabetes as selected from the table ‘My abnormalities history’ under section 501). This table indicates the date of updation in the header of the table as ‘Updated on 23^{rd} Jul. 2013’ {if 23^{rd} July 2013 was the date of updation (consultancy)}. This table has a link for entering details of ‘Medicines prescribed’ (503) on the date of updation (consultancy). On clicking this link, it shows as ‘My abnormalities history>>Diabetes>>Symptoms and treatment details>>Medicines prescribed by Dr. XYZ on 23^{rd} Jul. 2013’ (if Diabetes was selected from the ‘My abnormalities history’ table and 23^{rd} July 2013 was the date of consultation with Dr. XYZ).

The initial fields of ‘Symptoms and treatments details’ elements (502) can provide vital details of the user's (patient's) current symptoms, its uniqueness, other health issues, environmental exposure and other details relevant which provide details as entered out the abnormality, to the doctor at the time of consulting.

When the fields of the ‘medicines prescribed’ elements (503) are completed, a table listing details of medicines prescribed in the specific consultancy is displayed. Further, the fields of the ‘medicines prescribed’ elements (503) can be updated for each consultancy to provide comprehensive details of medicines and related details. Then, the health information in the fields of the symptoms and treatment details elements (502) and the medicines prescribed elements (503) are automatically collated and displayed through a link from the symptoms and treatment details elements (502) as symptoms and treatment history elements (504) for the selected abnormality, in the form of a table.

Based on the above steps, the health details of all the abnormalities listed in the abnormalities history section (501) can be completed to provide comprehensive and chronological view of all the abnormalities in the form of a table in the abnormalities history section (501) with a connecting link to the symptoms and treatment details elements (502) for recording individual consultation details, which in turn provides a links to the medicines prescribed elements (503) for recording details the medicines. Symptoms and treatment details element (502) also provides a link to symptoms and treatment history elements (504). All the outputs of the abnormalities history section (501), symptoms and treatment details elements (502), medicines prescribed elements (503) and symptoms and treatment history elements (504) of the abnormalities sub-module (302) are displayed in the form of tables (311) with appropriate heading, which can be viewed and printed through the print view (312) and the print command (313). For example, the abnormalities history section (501) has links to the symptoms and treatment details elements (502) for the selected abnormality and for the specific consultation, which in turn links to the medicines prescribed elements (503) for the specific consultation on a specific date by a specific doctor, which are collated and shown in the symptoms and treatment history elements (504) for the selected abnormality. The abnormality details in the abnormality sub-module (302) are saved and exported to the doctor module (104), which helps the doctor to have a quick overview of all the abnormalities as well as details of the specific abnormality for effective diagnosis and medical intervention

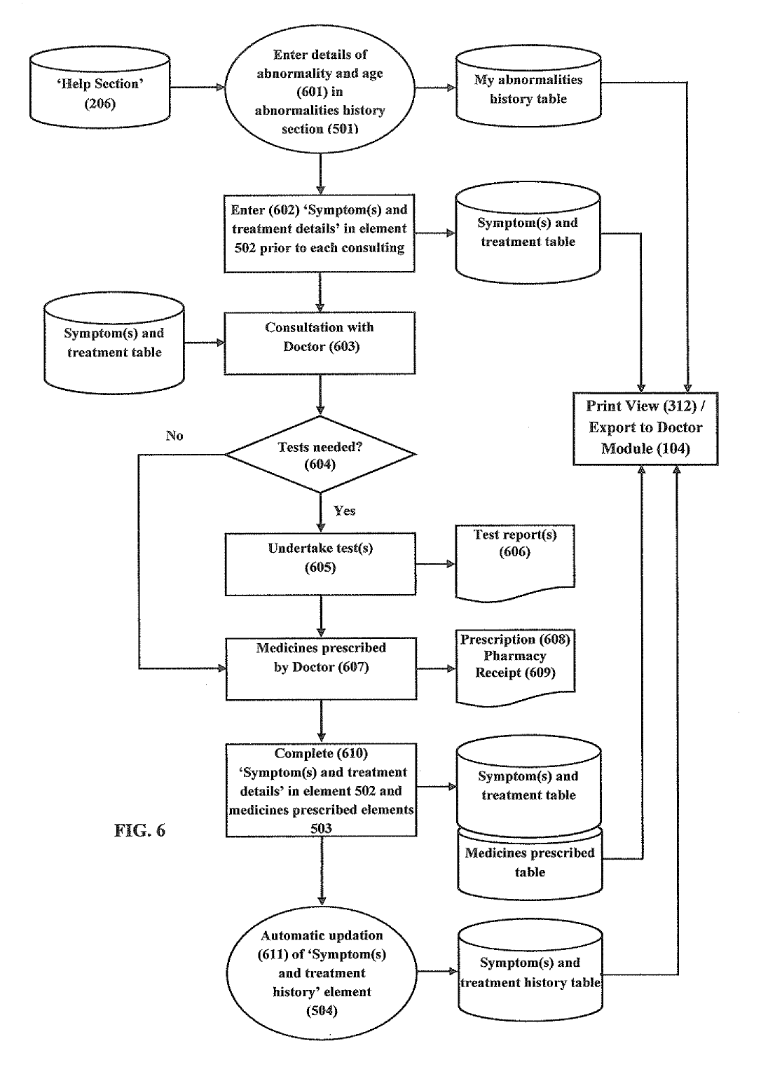

FIG. 6 illustrates a flowchart depicting a functional process of the abnormalities sub-module (302) of the user module (103), in accordance with an exemplary embodiment of the present invention. As depicted at step 601, details of abnormality and age are entered in the abnormalities history section (501), which generates the table ‘My abnormalities history’. This step can be done initially at the time of updating past data. Help of family members can be sought to avoid any missing information (including abnormalities related to childhood). This step 601 can be repeated when a new abnormality is experienced by the user. The types of abnormalities to be listed here are defined in the help section (206).

Then, as illustrated at step 602, the symptoms and treatment details are entered and updated in the fields of the symptoms and treatment detail elements (502) prior to each consulting, which generates the ‘Symptoms and treatment table’. The symptoms and treatment table can serve as ‘aide memoire’ for the user at the time of consulting to provide valuable inputs for diagnosis.

Then, as depicted at step 603, the user consults with the doctor based on the symptoms and treatment details entered in the table of the symptoms and treatment detail elements (502). After examination, the doctor determines the need for tests to be conducted, as shown at step 604. If so, tests are carried out on the user and test reports are obtained for the doctor review, as illustrated at steps 605 and 606. Further, even if no tests are carried out or after the tests are carried out, the medicines are prescribed by the doctor and then purchased with the help of doctor's prescription and the pharmacy receipt is obtained, as depicted at steps 607-609.

Thereafter, as shown at step 610, after the consultation, the remaining or unfilled fields of the symptoms and treatment detail elements (502) and the fields of the medicines prescribed elements (503) can be entered and updated based on the medicines prescribed by the doctor and the tests, if any. This step generates the ‘Medicines prescribed’ table for the specific abnormality/consultancy.

Then, as illustrated at step 611, the information from the symptoms and treatment detail elements (502) and the medicines prescribed elements (503) are retrieved automatically and collated to generate comprehensive health information in the symptoms and treatment history elements (504), which generates the ‘Symptoms and treatment history’ table for the specific abnormality. This table provides a bird's eye view of the specific abnormality from the time of first consulting.

All the outputs of the abnormalities history section (501) as well as symptoms and treatment detail elements (502), medicines prescribed elements (503) and symptoms and treatment history elements (504) are displayed in the form of tables (311) with appropriate heading, which can be viewed and printed through the print view (312) and the print command (313).

Further, the comprehensive and chronological detailed information about all the abnormalities of the user in the user module (103) {comprising of outputs of abnormalities history section (501), symptoms and treatment detail elements (502), medicines prescribed elements (503) and symptoms and treatment history elements (504)} are automatically exported to the doctor module (104) providing the doctor with necessary data leading to the appropriate medical intervention.

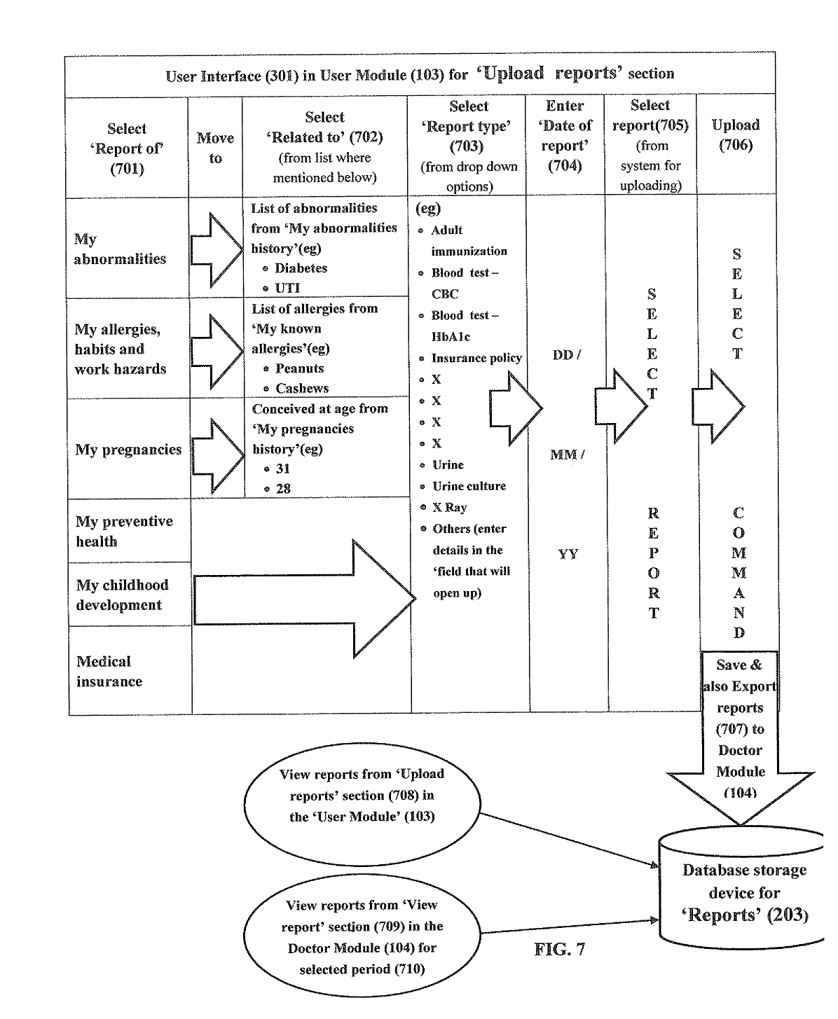

FIG. 7 illustrates a flowchart depicting a functional process of reports sub-module (303) of the user module (103), in accordance with an exemplary embodiment of the present invention. The reports sub-module (303) is preferably composed of upload report section and view report section (708, 709). The upload report section provides storage of reports preferably related to selected topics such as abnormalities, allergies, habits and work hazards, preventive health, childhood development, pregnancies and medical insurance. The reports uploaded from the upload report section are made available for viewing in the doctor module (104) under the view report section (709) in the report sub-module (303), where the view report section (709) has fields to help select and view reports based on selected criteria. The upload report section (708) is composed of various fields, preferably report of field (701), report relation field (702), report type field (703), report date field (704), report selection field (705) and report upload field (706). The report of field (701) is configured to select topics of the sub-modules (302-310) of the user module (103) to which the reports to be uploaded, where the topics of the sub-modules (302-310) include abnormalities, allergies, habits and work hazards, pregnancies, preventive health, childhood development and medical insurance.

For example, the topic of abnormalities, allergies, habits and work hazards, and pregnancies are selected in the report of field (701). Then, the report relation field (702) is displayed to select sub topics relating to the topics selected in the sub-modules (302-310), i.e. the topic of abnormalities, allergies, habits and work hazards, and pregnancies. The topics to be displayed are automatically transferred from details already entered in the respective sections of the sub-modules (302-310) of the user module (103). Examples of topics in the report relation field (702) can be say ‘Diabetes, Heart attack, UTI etc’ under the abnormalities history sub-module (302); ‘Peanuts’, ‘Cashews etc’ under the allergies, habits and work hazards, sub-module (304) and ‘Conceived at 26, 31 etc’ in the pregnancies sub-module (308). Then, these topics can help to choose the sub topics in the report relation field (702).

Once the sub-topics are selected in the respective topics, then the report type field (703) is displayed to select the type of reports such as adult immunization, blood test, urine, urine culture,Xray, others, etc. The report types can be predefined to allow the user to simply select the report type from the drop down option in the report type field (703). Once the report types are selected in the respective sub-topics, then date of report has to be entered in the report date field (704). The reports are selected by the user in the report field (705) to upload the reports in the report upload field (706). Once the reports are uploaded they are automatically saved in the database storage device (203) and the saved reports are made available in the doctor module (104) for viewing.

In the user module (103), the saved and exported reports are traceable to the particular health topic (i.e. abnormalities, allergies, habits and work hazards, pregnancies history, preventive health, childhood development and medical insurance) with the sub-topic (i.e. specific abnormality, allergen or pregnancy, etc), the particular report type (e.g. Blood test, ECG, etc) and the particular date of report. The list of reports is preferably saved in a chronological table, with the latest appearing at the top. The selected reports of the individual user can be viewed in the upload report section (708) in the user module (103) as well as viewed in the view report section (709) in the doctor module (104). In the doctor module (104), the reports are traceable based on the report of field (701), the report relation field (702) and the report type field (703) as well as date of report (704). The report period field (710) provides an option of choosing varying period of reports such as last 1 month, last 3 months, etc. Thus, the report sub-module (303) provides selection and viewing of the particular report from the entire list of reports uploaded in the system or for the selected period in order to facilitate any combination of reports to be quickly selected and viewed.

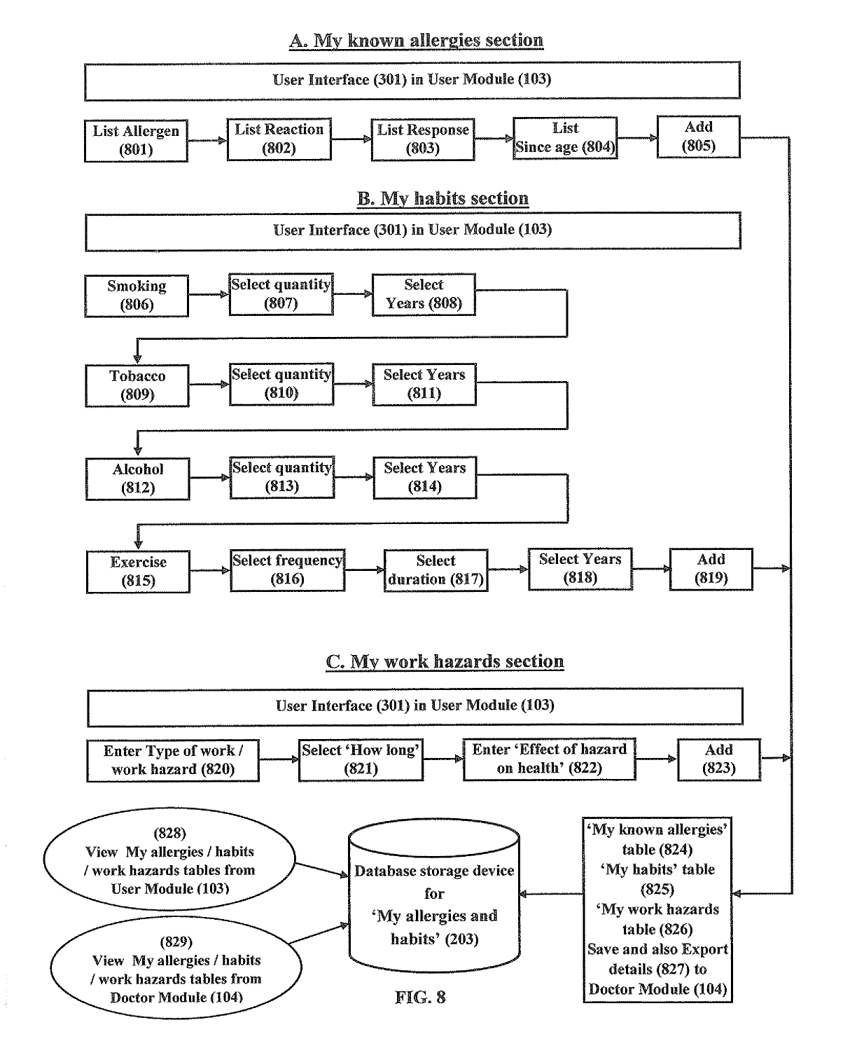

FIG. 8 illustrates a flowchart depicting a functional process of allergies, habits and work hazards sub-module (304) of the user module (103), in accordance with an exemplary embodiment of the present invention. The allergies, habits and work hazards sub-module (304) is preferably configured for capturing allergies, habits and work hazards of the individual user, which can be exported to the doctor module (104) for precaution or diagnosis (i.e. recommending preventive healthcare or diagnosis or medical intervention). The allergies, habits and work hazards sub-module (304) is primarily composed of known allergies section, habits section and work hazards section. In particular, in the known allergies section of the allergies, habits and work hazards sub-module (304), initially allergen(s) are identified and the reaction of the individual user for the identified allergen(s) is recorded, as depicted at the steps 801 and 802. Then, as illustrated at steps 803-804, the response to the reaction of the allergen is recorded, along with the age at which the reaction to allergen is first noticed. Then, as illustrated at step 805, add is entered such that the details of list of allergen with its reaction and response captured in the known allergies section can be saved, created and displayed in a known allergies table (824).

Similarly, the habits section of the allergies, habits and work hazards sub-module (304) is configured to capture details of habits such as ‘Smoking’, Tobacco′, ‘Alcohol’ and ‘Exercise’, etc, of the individual user. Preferably, as illustrated at steps 806-818, quantity and years are selected and entered individually for smoking, tobacco and alcohol as well as frequency, duration and years are selected and entered for exercise. Then, as illustrated at step 819, add is entered such that the details of habits captured in the habits section can be saved, created and displayed in a habit table (825).

Similarly, the work hazards section of the allergies, habits and work hazards sub-module (304) is configured to capture details of work hazards such as ‘Type of work/work hazards’, ‘How long’ and Effect of hazard on health′. Initially work/work hazard of the individual user is identified and recorded as depicted in 820. For example, this hazard could arise either due to professional or personal activities or during the course of its execution (such as long travel to work). Then, as illustrated at steps 821 and 823, how long and effect of work hazard are recorded. Then, as illustrated at step 823, add is entered such that the details of type of work/work hazard, how long and effect of hazard on health captured in the work hazard section can be saved, created and displayed in a known work hazards table (826).

The details of allergies, habits and work hazards are entered by the user through the user interface (301) in the user module (103). Further, as indicated at steps 827 and 828, the details of allergies, habits and work hazards are viewed by the user from the user module (103) and are saved in the database storage device (203) of the EMRI module (102). Then, as shown at steps 827 and 829, the details of allergies, habits and work hazards are also exported to the doctor module (104) for viewing it from the doctor module (104).

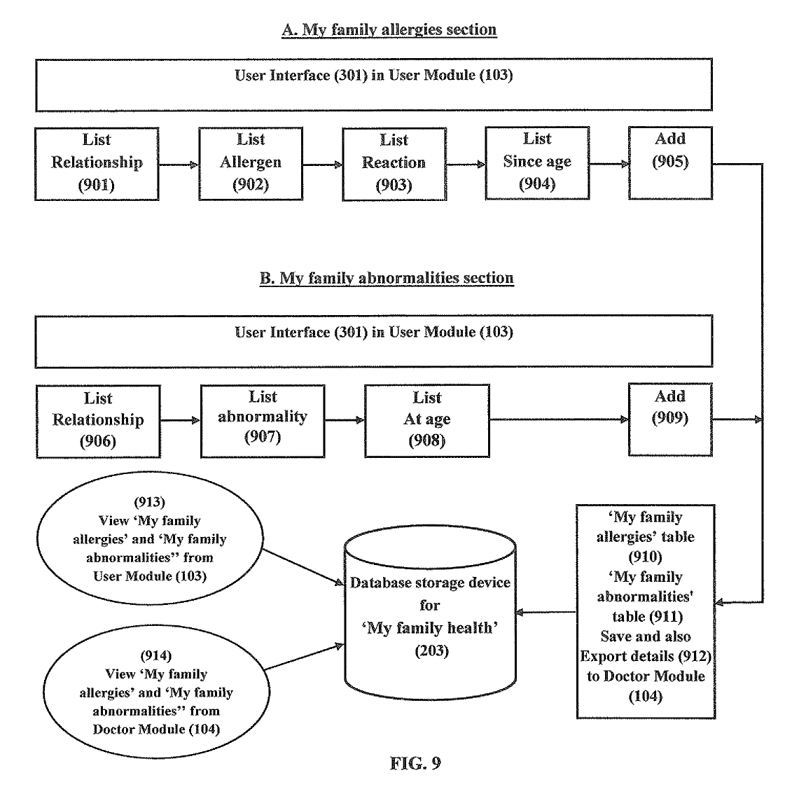

FIG. 9 illustrates a flowchart depicting a functional process of family health sub-module (305) of the user module (103), in accordance with an exemplary embodiment of the present invention. The family health sub-module (305) is configured to preferably capture allergies and abnormalities of blood relatives (like father, mother, siblings etc) of the individual user, which can be exported to the doctor module (104) for diagnosis or medical intervention or preventive health. Such details help the doctor to recommend preventive healthcare to the user (patient), even though the user has consulted the doctor for some other health issue. The family health sub-module (305) is primarily composed of family allergies section and family abnormalities section. In particular, in the family allergies section of the family health sub-module (305), initially relationship is selected and allergens and the reaction(s) to the identified allergen(s) are identified, along with the age at which the allergen(s) are first noticed, for the selected family member of the individual user, as depicted at the steps 901-904. Then, as illustrated at step 905, add is entered such that the details of list of allergen with its reaction and response identified for the selected family member can be created and saved. The steps of 901-905 can be repeated for all other blood relatives of the individual user. Thus the details of list of allergen(s) with its reaction(s) and age captured in the family allergies section can be created, saved, and displayed in a family allergies table (910).

Similarly, in the family abnormalities section of the family health sub-module (305), initially relationship is selected and abnormalities are identified and recorded along with the age at which the abnormalities are first experienced by the family member of the individual user, as depicted at the steps 906-908. Then, as illustrated at step 909, add is entered such that the details of list of abnormalities identified for the selected family member can be created and saved. The steps of 906-909 can be repeated for all other blood relatives of the individual user. Thus the details of list of abnormalities captured in the family abnormalities section can be created, saved, and displayed in a family abnormalities table (911). The details of family allergies and abnormalities are entered by the user through the user interface (301) in the user module (103). Further, as indicated at steps 912 and 913, the details of family allergies and abnormalities are viewed by the user from the user module (103) and are saved in the database storage device (203) of the EMRI module (102). Then, as shown at steps 912 and 914, the details of family allergies and abnormalities are also exported to the doctor module (104) for viewing it from the doctor module (104).

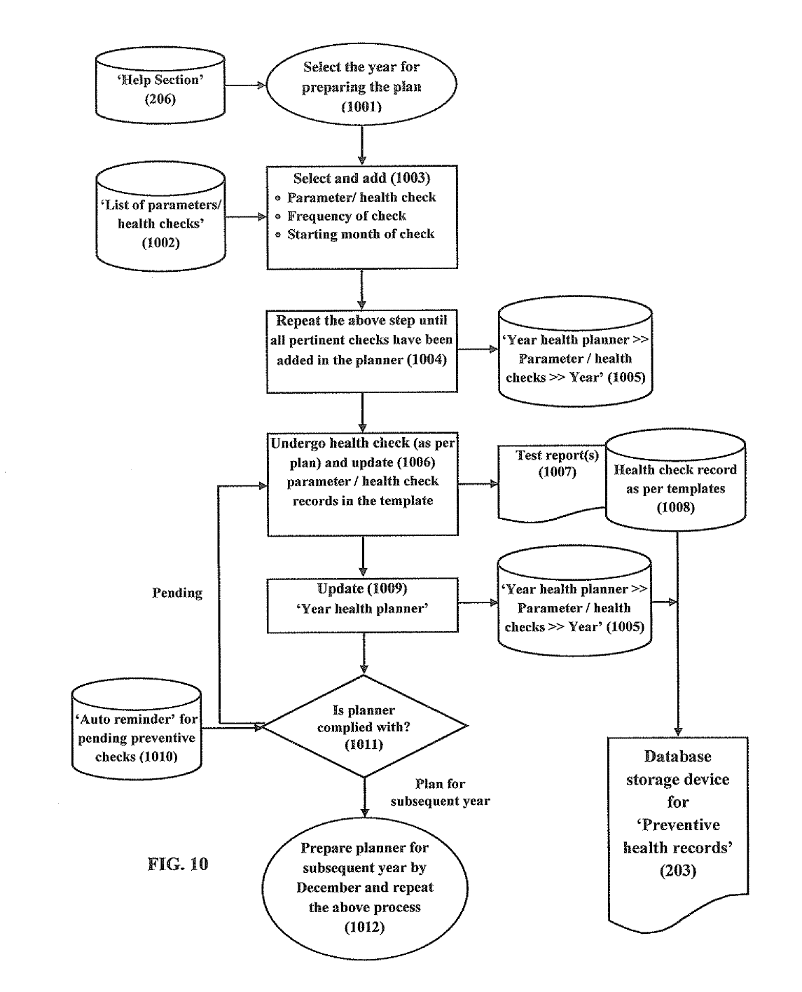

FIG. 10 illustrates a flowchart depicting a functional process of preventive health sub-module (306) of the user module (103), in accordance with an exemplary embodiment of the present invention. The preventive health sub-module (306) helps the individual user to plan and implement a preventive health event in a systematic manner, which helps the individual user to stay healthy, identify potential out of control health condition and help seek timely medical intervention. As depicted at step 1001, the individual user selects the year for preparing a preventive health planner, where the resultant output is displayed as a table listing all the previous years (if planned earlier) and the selected year. Then, as illustrated at step 1003, parameter/health check, frequency of check and period of check (such as starting month of check) can be selected from a list of parameter/health checks (1002). The steps 1001-1003 can be repeated until all the relevant parameters and health checks are added to the preventive health planner, where the resultant output is displayed as “Year health planner>>Parameter/health checks>>Year”, as depicted at step 1005.

Then, as shown at steps 1006-1008, the health check is undergone by the individual user as per the plan, and is updated and recorded in predefined templates along with test reports. Further, the details recorded are displayed as tables for all parameters and also as trend graphs for some parameters, which are accessed through the user interface (301) and viewed only in the user module (103). Then, as shown at step 1009, the preventive health planner is updated based on the updated health check, where the details of the preventive health planner are saved and recorded in the database storage device (203) of the EMRI module (102). As depicted at step 1011, determination is made whether the preventive health planner is periodically complied or not. If the preventive health planner is not periodically complied, then auto reminder for the pending preventive checks is displayed to the individual user and the steps 1006 and 1009 are repeated, as illustrated at steps 1010 and 1011. Similarly, the preventive health planner can be prepared and implemented for subsequent year (i.e. by December month) by repeating the above steps, as shown at step 1012. The details of planner in the preventive health sub-module (306) can be entered by the user through the user interface (301) and can be viewed only in the user module (103).

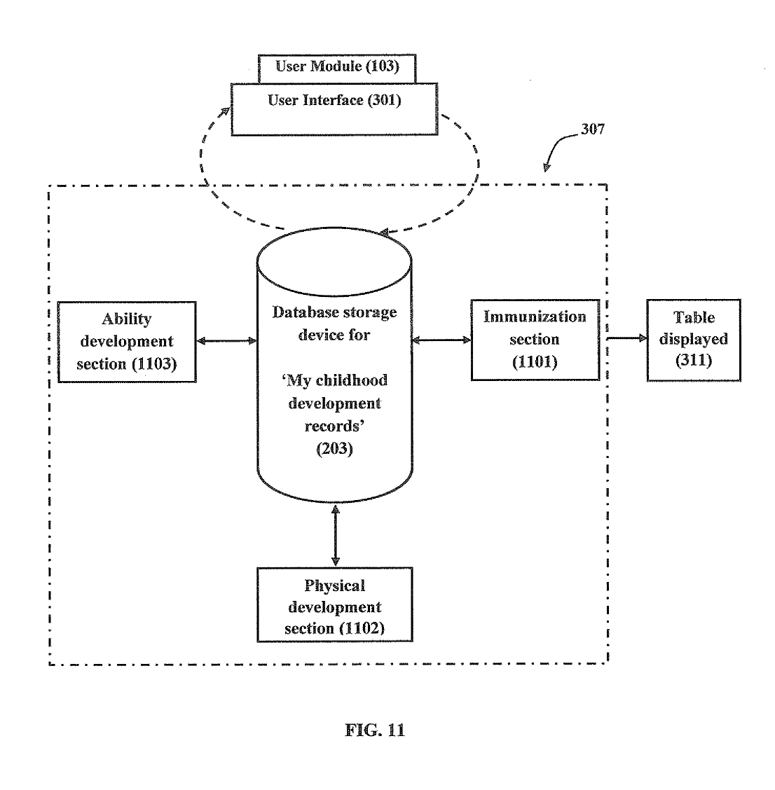

FIG. 11 illustrates a block diagram of the childhood development sub-module (307) of the user module (103), in accordance with an exemplary embodiment of the present invention. The childhood development sub-module (307) in the user module (103) is preferably composed of immunization section (1101), physical development section (1102) and ability development section (1103), where these immunization, physical development and ability development sections (1101-1103) are linked and connected with the database storage device (203) of the EMRI module (102). The three sections (1101-1103) of the childhood development sub-module (307) can help a parent or caretaker to track and monitor the early developmental needs of their child or ward, which helps the child to stay healthy, identify potential out of control conditions and help seek timely medical intervention. The details of childhood development can be accessed through the user interface (301) in the user module (103) and displayed in the form of table (311) in the user module (103).

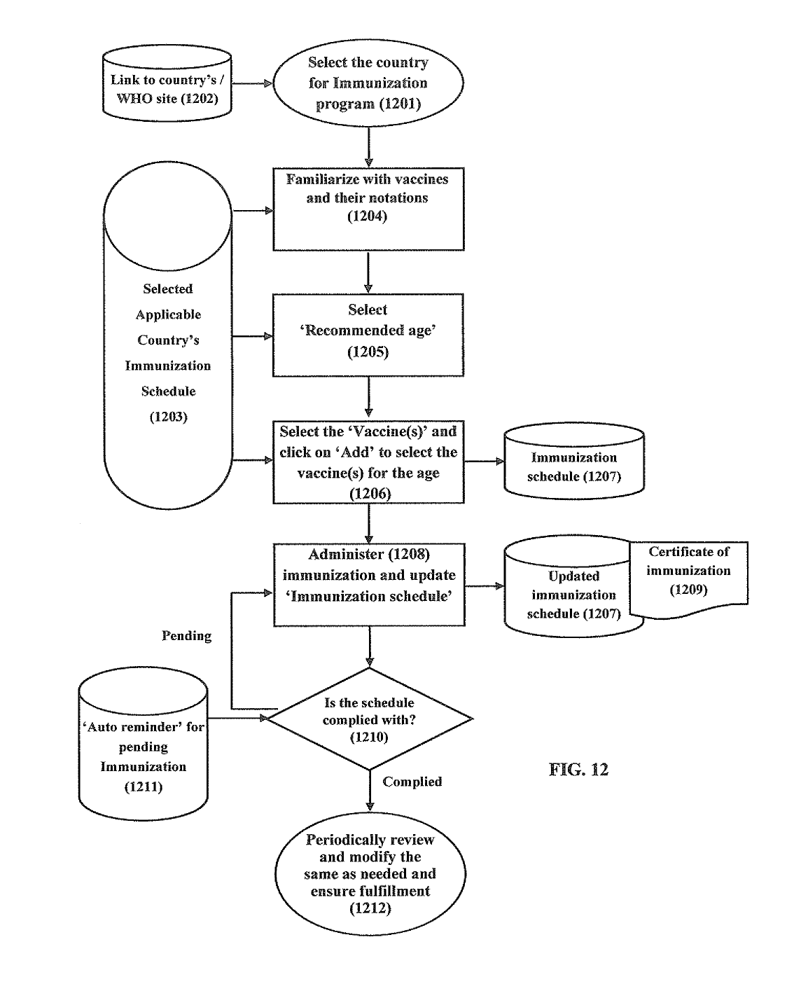

FIG. 12 illustrates a flowchart depicting a functional process of immunization section (1101) of the childhood development sub-module (307) of the user module (103), in accordance with an exemplary embodiment of the present invention. The immunization (or vaccination) section (1101) of the childhood development sub-module (307) is configured to prepare and recording an immunization schedule for the child considering many factors such as gender and country to ensure timely immunization. Initially, as depicted at steps 1201 and 1202, the country for the immunization program is selected from the list of countries by accessing the selected countries or WHO's website. Then, as shown at steps 1203 and 1204, vaccines and its notations can be acquired and familiarized from the immunization schedule of the selected country, where the similar vaccines can be used with different notation by different countries. Then, as illustrated at steps 1205-1207, recommended age and corresponding vaccine are selected with reference to the schedule in the selected country for preparing the immunization schedule in the immunization section (1101). The immunization schedule can be displayed as a table listing the due date for the selected vaccines, where the due date is automatically computed from the ‘Date of birth’ details entered at the time of creating the account.

Further, as depicted at steps 1207-1209, the immunization can be administrated and updated as per immunization schedule to obtain a certificate of immunization, which avoids an unnecessary repeat of the similar immunization later for want of record. As depicted at step 1210, determination is made whether the immunization schedule is periodically complied or not. If the immunization schedule is not periodically complied, then auto reminder for the pending immunization is displayed to the individual user and the step 1208 is repeated, as illustrated at steps 1210 and 1211. Similarly, as shown at step 1212, if the immunization schedule is periodically complied, then the immunization schedule can be periodically reviewed and modified to ensure fulfillment. The details of immunization schedule in the immunization section (1101) can be accessed through the user interface (301) and viewed only in the user module (103).

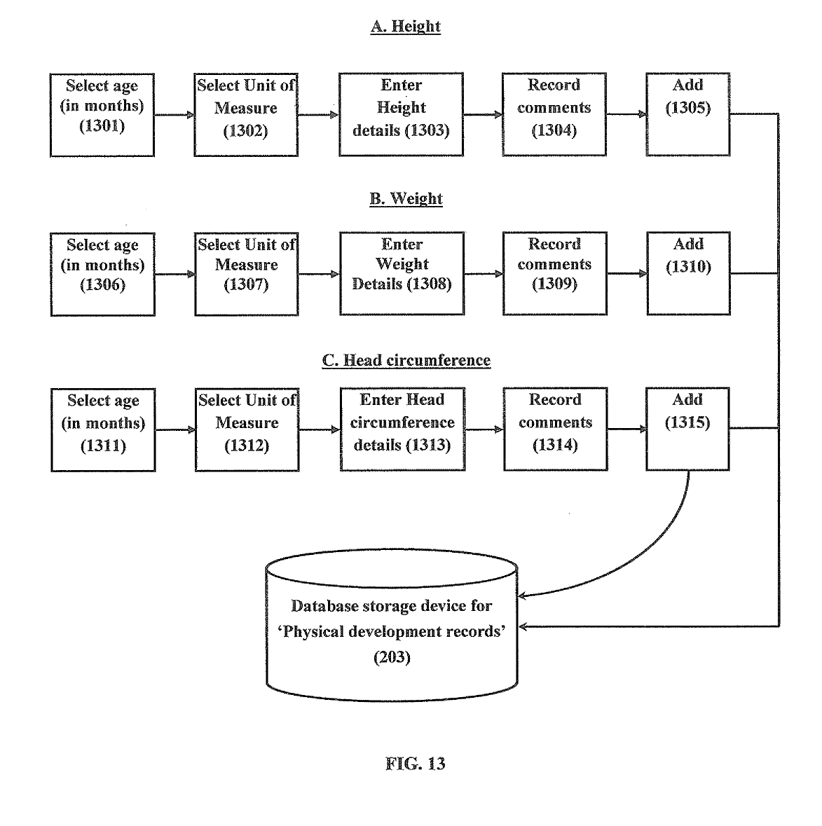

FIG. 13 illustrates a flowchart depicting a functional process of physical development section (1102) of the childhood development sub-module (307) of the user module (103), in accordance with an exemplary embodiment of the present invention. The physical development section (1102) of the childhood development sub-module (307) is configured to track and record child physical growth, which helps the parent or guardian to track the physical development of the child covering height, weight and head circumference, etc. The childhood development sub-module (307) is preferably composed of height element (A), weight element (B) and head circumference element (C). In the height element of the childhood development sub-module (307), height details of the child are entered and recorded along with related growth comments through the user interface (301) in the user module (103) after selecting age in months and unit of measure, as depicted at the steps 1301-1304. Then, as illustrated at step 1305, add is entered such that the height details of the childhood development sub-module (307) are saved in the database storage device (203) of the EMRI module (102).

Likewise, in the weight element of the childhood development sub-module (307), weight details of the child are entered and recorded along with related growth comments through the user interface (301) in the user module (103) after selecting age in months and unit of measure, as depicted at the steps 1306-1309. Then, as illustrated at step 1310, add is entered such that the weight details of the childhood development sub-module (307) are saved in the database storage device (203) of the EMRI module (102). Similarly, in the head circumference element of the childhood development sub-module (307), head circumference details of the child are entered and recorded along with related growth comments through the user interface (301) in the user module (103) after selecting age in months and unit of measure, as depicted at the steps 1311-1314. Then, as illustrated at step 1315, add is entered such that the head circumference details of the childhood development sub-module (307) are saved in the database storage device (203) of the EMRI module (102). Further, the details entered in all the three elements of the childhood development sub-module (307) are displayed as tables and trend graphs, which are accessed through the user interface (301) and viewed only in the user module (103).

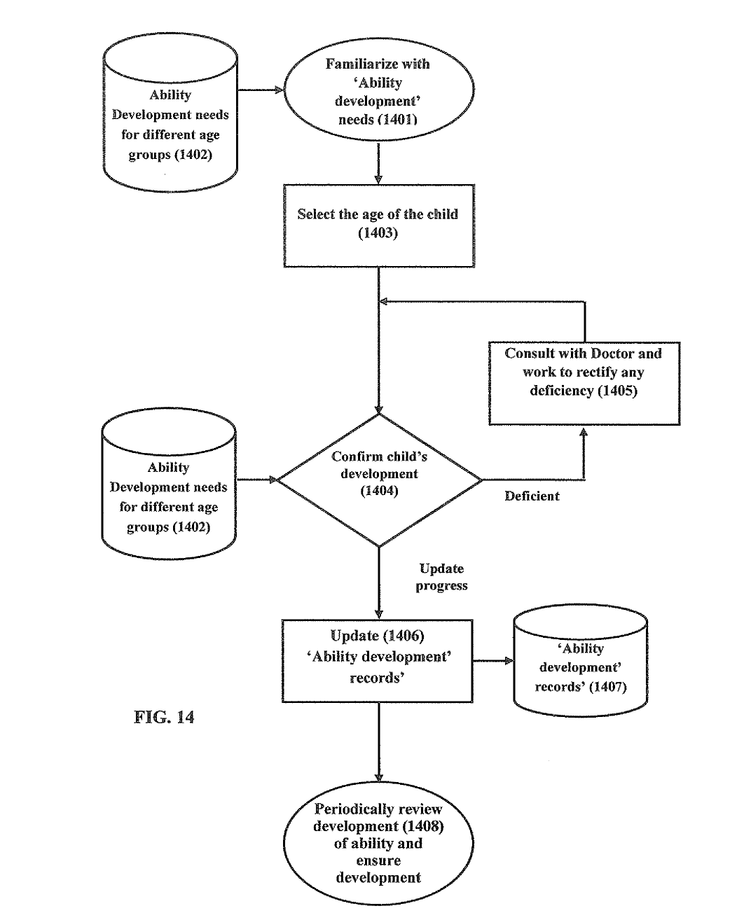

FIG. 14 illustrates a flowchart depicting a functional process of ability development section (1103) of the childhood development sub-module (307) of the user module (103), in accordance with an exemplary embodiment of the present invention. The ability development section (1103) of the childhood development sub-module (307) is configured to record development of various abilities of the child, which helps the parent or guardian to track and cross check the development of various abilities of the child and initiate action if any shortcoming is evidenced. Initially, as depicted at steps 1401 and 1403, ability development needs of the child at different age groups (1402) are familiarized before selecting the age of the child. Then, as illustrated at step 1404, upon selecting the child age at which the ability needs to be tracked, child ability development is compared and checked with the ability development needs of the child at the selected age group (1402). As depicted at step 1405, if the child ability development is deficient, efforts can be initiated to rectify any deficiency by timely consulting with doctor. Whereas, the child ability development is updated and progress recorded, as shown at steps 1406 and 1407. Then, as depicted at step 1408, the child ability development can be periodically reviewed and updated to ensure development. The details of child abilities in the ability development section (1103) can be accessed through the user interface (301) and viewed only in the user module (103).

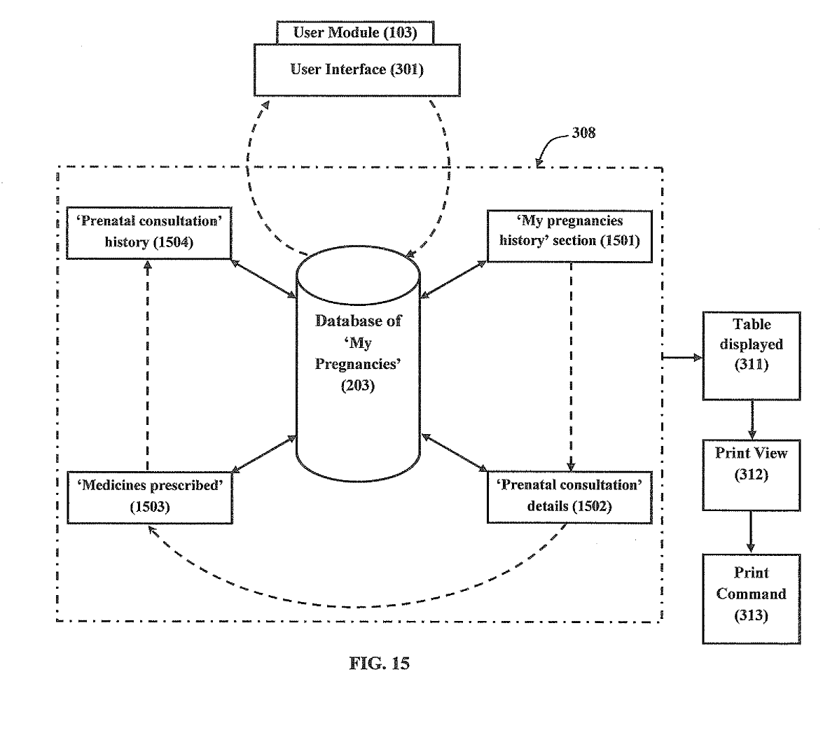

FIG. 15 illustrates a block diagram of the pregnancies sub-module (308) of the user module (103), in accordance with an exemplary embodiment of the present invention. The pregnancies sub-module (308) is activated only when the gender is entered as ‘Female’ at the time of creating the account. The pregnancies sub-module (308) is well linked and preferably composed of pregnancies history section (1501), prenatal consultation details elements (1502), medicines prescribed elements (1503) and prenatal consultation history elements (1504).

The pregnancies history section (1501), the prenatal consultation details elements (1502), the medicines prescribed elements (1503) and the prenatal consultation history elements (1504) of the pregnancies sub-module (308) are connected and linked to the database storage device (203), where the pregnancy details in the pregnancies sub-module (308) can be accessed through the user interface (301) of the user module (103).

The information generated from the pregnancies history section (1501) is a simple table providing the woman user's pregnancy details and providing quick connectivity to other elements of the pregnancies sub-module (308) in a well linked manner. The pregnancies history section (1501) is preferably composed of fields of pregnancy conceived at age, special health condition, delivery type and childbirth notes. The pregnancies sub-module (308) is also provided with the help section (206) that lists categories of pregnancies that need to be considered while entering/updating details in this section.

The prenatal consultation detail elements (1502) provide details of each consultation for a specific pregnancy. The prenatal consultation details elements (1502) is configured to record every prenatal consultation details of each of the pregnancies entered in pregnancies history section (1501) and is preferably composed of fields of current health issues, missing requirements (for physical/mental well being of the woman user), hospital/patient reference number, doctor name, test taken, observation and diagnosis, medical intervention or procedure, medicines prescribed, doctor's advice, effectiveness of medicines or medical intervention, date of update, etc.

Some of the fields of the prenatal consultation detail elements (1502) are completed prior to consultation and the rest after consultation, where the initial fields can provide vital details of the pregnant woman's current health issues with the complete details of the past consulting. This way, the pregnant woman is benefited by providing all current, pertinent and past information to the doctor. The user module (103) of the EMRI module (102) provides for updation in the prenatal consultation detail elements (1502) post consultation, covering many subjects including doctor (consulted), tests taken, observation & diagnosis, medicines prescribed, medical intervention and procedure, doctor's advice, effectiveness of medicines/medical intervention, updated on date etc.

The medicines prescribed elements (1503) is preferably composed of fields of medicine with strength, dosage unit, with respect to food (eg. before or after food), morning (quantity), noon (quantity), night (quantity), anytime of the day (quantity), for number of days, etc. The essence of prenatal consultation detail elements (1502) and medicines prescribed elements (1503) are automatically summarized as the prenatal consultation history elements (1504).

When the fields of the pregnancies history section (1501) are entered and completed, a table listing chronological details of all pregnancies of the woman is displayed under the heading of ‘My pregnancies history’. On selecting any pregnancy from this table (My pregnancies history), the fields of the prenatal consultation detail elements (1502) are available for entering or updation of details for the selected pregnancy (such as ‘conceived at age 26’), with the date of consultancy. When the fields for the prenatal consultation detail elements (1502) are completed, a table is generated under the heading ‘Prenatal consultation details’ with the updated on date (date of consultancy), wherein the fields of the ‘medicines prescribed’ elements (1503) are available for entering details of medicines prescribed on the updated date (date of consultancy) for the specific pregnancy.

For example, when the fields of ‘Prenatal consultation details’ elements (1502) are entered/updated, a table is generated with heading as ‘My pregnancies history>>Conceived at age 26>>Prenatal consultation details’ (if the details to be entered or updated pertain to ‘conceived at the age of 26 as selected from the table ‘My pregnancies history’ under section 1501). This table indicates the date of updation in the header of the table as ‘Updated on 10^{th} Mar’ 2014′ {if 10^{th} Mar′ 2014′ was the date of updation (consultancy)}. This table has a link for entering details of ‘Medicines prescribed’ (1503) on the date of updation (consultancy). On clicking this link, it shows as ‘My pregnancies history>>Conceived at age 26>>Prenatal consultation details>>Medicines prescribed by Dr. ABC on 10^{th} Mar’ 2014′ (if conceived at age 26 was selected from the ‘My pregnancies history’ table and 10^{th} Mar’2014 was the date of consultation with Dr. ABC).

The initial fields of ‘Prenatal consultation details’ elements (1502) can provide vital details of the pregnant woman's current health issues (i.e. physical, mental or psychological), which provides all current information and other relevant details as entered about the pregnancy, to the doctor at the time of consulting.

When the fields of the ‘medicines prescribed’ elements (1503) are completed, the table listing details of medicines prescribed in the specific consultancy is displayed. Further, the fields of the ‘medicines prescribed’ elements (1503) can be updated for each consultancy to provide comprehensive details of medicines and related details. Then, the health information in the fields of the prenatal consultation detail elements (1502) and the medicines prescribed elements (1503) are automatically collated and displayed through a link from the prenatal consultation detail elements (1502) as prenatal consultation history elements (1504) for the selected pregnancy, in the form of a table.

Based on the above steps, the details of all pregnancies listed in the pregnancies history section (1501) can be completed to provide comprehensive and chronological view of all the pregnancies in the form of a table in the pregnancies history section (1501) with a connecting link to the prenatal consultation details elements (1502) for recording individual consultation details, which in turn provides a link to the medicines prescribed elements (1503) for recording details the medicines. Prenatal consultation details element (1502) also provides a link to prenatal consultation history elements (1504). All the outputs of the pregnancies history section (1501), the prenatal consultation details elements (1502), the medicines prescribed elements (1503) and the prenatal consultation history elements (1504) of the pregnancies sub-module (308) are displayed in the form of tables (311) with appropriate heading, which can be viewed and printed through the print view (312) and the print command (313). For example, the pregnancies history section (1501) has links to the prenatal consultation details elements (1502) for the selected pregnancy and for the specific consultation, which in turn links to the medicines prescribed elements (1503) for the specific consultation on a specific date by a specific doctor, which are collated and shown in the prenatal consultation history elements (1504) for the selected pregnancy. The pregnancy details in the pregnancies sub-module (308) are saved and exported to the doctor module (104), which helps the doctor to have a quick overview of all the pregnancies as well as details of the specific pregnancy for effective diagnosis and for safe pregnancy.

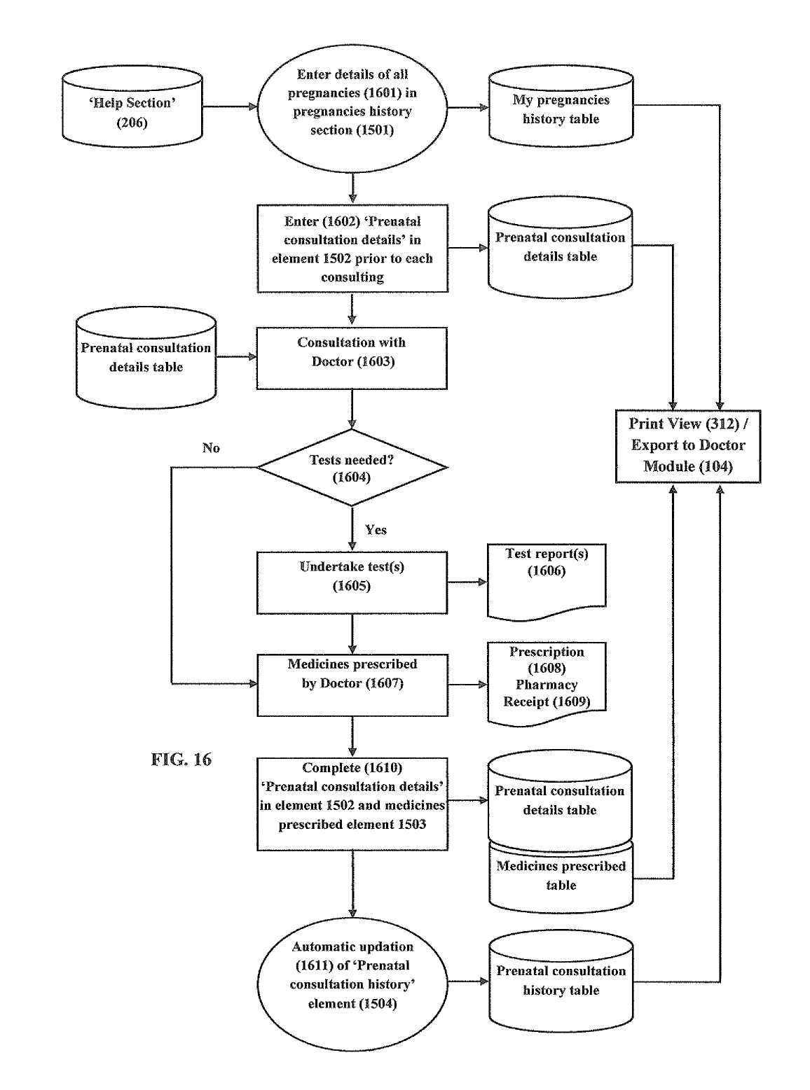

FIG. 16 illustrates a flowchart depicting a functional process of the pregnancies sub-module (308) of the user module (103), in accordance with an exemplary embodiment of the present invention. As depicted at step 1601, details of all pregnancies such as conceived at, special condition, types of delivery, notes related to childbirth are entered in the pregnancies history section (1501), which generates the table ‘My pregnancies history’. This step can be done initially at the time of updating past data. This step 1601 can be repeated when new pregnancy or pregnancy issues are experienced by the woman user. The types of pregnancies to be listed here are defined in the help section (206).

Then, as illustrated at step 1602, the prenatal consultation details are entered and updated in the fields of the prenatal consultation detail elements (1502) prior to each consulting, which generates the ‘Prenatal consultancy table’. The prenatal consultation table can serve as ‘aide memoire’ for the woman user at the time of consulting to provide valuable inputs for consultation leading to safe pregnancy and delivery.

Then, as depicted at step 1603, the user consults with the doctor based on the prenatal consultation details entered in the table of the prenatal consultation details elements (1502). After examination, the doctor determines the need for tests to be conducted, as shown at step 1604. If so, tests are carried out on the user and test reports are obtained for the doctor review, as illustrated at steps 1605 and 1606. Further, even if no tests are carried out or after the tests are carried out, the medicines are prescribed by the doctor and then purchased with the help of doctor's prescription and the pharmacy receipt is obtained, as depicted at steps 1607-1609.

Thereafter, as shown at step 1610, after the consultation, the remaining or unfilled fields of the prenatal consultation details elements (1502) and the fields of the medicines prescribed elements (1503) can be entered and updated based on the medicines prescribed by the doctor and the tests, if any. This step generates the ‘Medicines prescribed’ table for the specific pregnancy/consultancy.

Then, as illustrated at step 1611, the information from the prenatal consultation details elements (1502) and the medicines prescribed elements (1503) are retrieved automatically and collated to generate comprehensive pregnancy information in the prenatal consultation history elements (1504), which generates the ‘Prenatal consultation history’ table for the specific pregnancy. This table provides a bird's eye view of the specific pregnancy from the time of first consulting.

All the outputs of the pregnancies history section (1501) as well as the prenatal consultation details elements (1502), medicines prescribed elements (1503) and prenatal consultation history elements (1504) are displayed in the form of tables (311) with appropriate heading, which can be viewed and printed through the print view (312) and the print command (313) in the user module (103).

Further, the comprehensive and chronological detailed information about all the pregnancies of the woman user in the user module (103) {comprising of outputs of prenatal history section (1501), prenatal consultation details elements (1502), medicines prescribed elements (1503) and prenatal consultation history elements (1504)} are automatically exported to the doctor module (104) providing the doctor with necessary data for medical intervention leading to safe pregnancy and delivery.

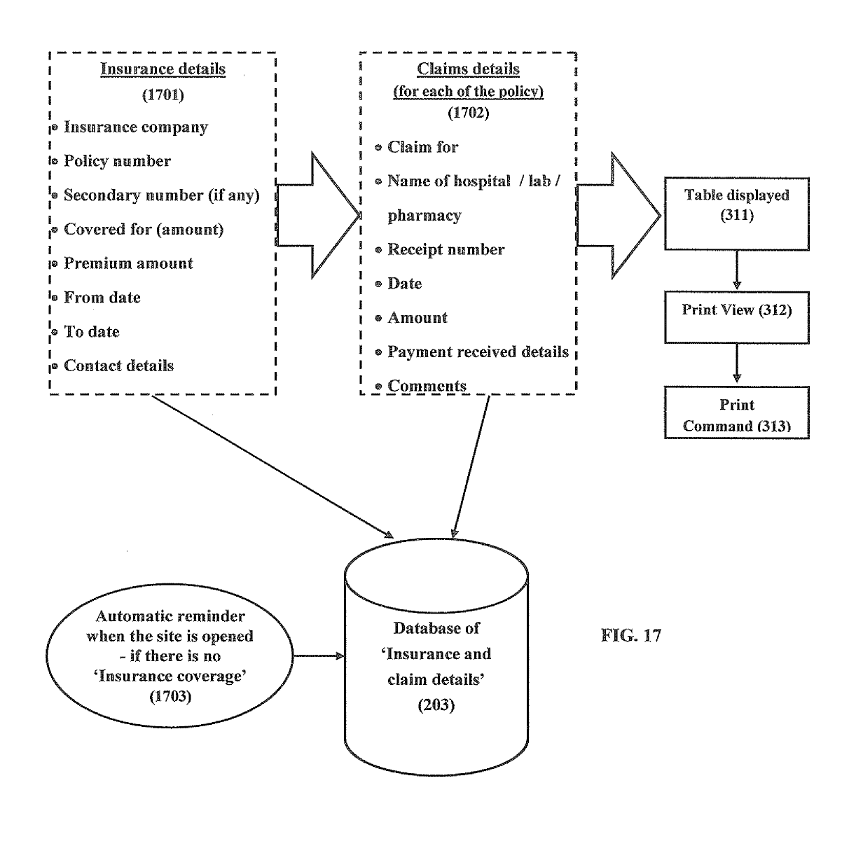

FIG. 17 illustrates a flowchart depicting a functional process of medical insurance sub-module (309) of the user module (103), in accordance with an exemplary embodiment of the present invention. The medical insurance sub-module (309) is connected to the database storage device (203) and recorded with insurance details and claim details, preferably details of policy, coverage, premium amount, validity and link to claims and payment receipt, besides other relevant details. Initially, as depicted at steps 1701 and 1702, the insurance details are registered for entering and updating the claim details for each of the insurance policies. For example, the insurance details include insurance company name, policy number, secondary number (if any), policy coverage amount, premium amount, policy begin date, policy end date, contact details, etc, whereas the claim details include claim reason, name of hospital or lab or pharmacy, receipt number, date, amount, payment received details, comments, etc. If there is no insurance coverage or the policy is not renewed, then auto reminder for the no insurance or pending insurance details is displayed to the individual user, as illustrated at step 1703. The insurance details and the claim details in the insurance sub-module (309) are saved in the database storage device (203) of the EMRI module (102), which are accessed and viewed through the user interface (301) in the user module (103). Further, the insurance details and the claim details entered in the insurance sub-module (309) are displayed in the form of table (311) with appropriate heading, which can be printed through the print view (312) and the print command (313) in the user module (103).

FIG. 18 illustrates a detailed block diagram of the doctor module (104), in accordance with an exemplary embodiment of the present invention. The doctor module (104) is interfaced with the user module (103) and is operated by the user through the user interface (301) for doctor's viewing of health information and reports stored in the database storage device (203) in order to provide the effective diagnosis. The abnormalities sub-module (302), the reports sub-module (303), the allergies, habits and work hazards sub-module (304), the family health sub-module (305) and the pregnancies sub-module (308) (for females) can be accessed and viewed in the doctor module (104). In particular, in the abnormalities sub-module (302), the health information and details of the individual user recorded in the abnormalities history section (501), the symptoms and treatment detail elements (502), the medicines prescribed elements (503) and the symptoms and treatment history elements (504) can be accessed and viewed in the doctor module (104).

Likewise, in the reports sub-module (303), the information about report of, report relation, report type and report period of the individual user can be accessed and viewed in the doctor module (104). In the allergies, habits and work hazards sub-module (304), allergies (304A), habits (304B) and work hazards (304C) of the individual user can be accessed and viewed in the doctor module (104). In the family health sub-module (305), family allergies (305A) and family abnormalities (305B) of the individual user can be accessed and viewed in the doctor module (104). Further, in the pregnancies sub-module (308), the pregnancy details of the women user recorded in the pregnancies history section (1501), the prenatal consultation details elements (1502), the medicines prescribed elements (1503) and the prenatal consultation history elements (1504) can be accessed and viewed in the doctor module (104). This doctor module (104) is configured for only viewing health information and reports exported from the user module (103), which presents necessary and holistic inputs for the doctor for the purpose of effective diagnosis of the individual user.

FIG. 19 illustrates a block diagram of the PIE module (105) of the integrated system (101); in accordance with an exemplary embodiment of the present invention. The PIE module (105) is designed primarily to share the ‘experiential learning with symptoms and related medical intervention’ details (My experiences with symptoms), in an easily understandable manner to improve the knowledge on health management for the benefit of another individual user as well as the society at large. The PIE module (105) is designed and developed to be simple and user friendly to facilitate meaningful submission and search for such experiences, considering variation in patient profile and absence of stratified or standardized description of symptoms.

The PIE module (105) is configured to share invaluable lessons learnt from the medical intervention journey for an abnormality and trauma related experience for preventive healthcare or precautions or early medical intervention. For example, the PIE module (105) helps the non-medical person to recognize the symptom(s) and its uniqueness in a particular part of the body, i.e. severe pain in the chest, ulcer in mouth, giddiness, fatigue, poor vision at nights, irritation while urinating, constant irritation in left eye, constant watering in right eye, frequent urination, high temperature not coming down, etc., and to search and relate with an experience with respect to body parts in describing the symptom(s), before reaching out to the doctor.

The PIE module (105) has simple architecture and templates for sharing and searching of the experience with symptoms of the individual user by selecting drop down options, where the shared experiences of the user can be stored based on a set of user selected criteria to facilitate easy search ability and for viewing. The PIE module (105) contains a list of several easily recognizable symptom(s) to facilitate any user to select/describe the symptom(s) matching the experience, which can help in preparing the inputs for consultation, where the improved awareness and documentation can provide valuable inputs to the sub-modules (302-310) of the EMRI module (102). The PIE module (105) helps to raise the awareness of the individual user in health management and also has a two way link of information flow between the EMRI module (102) and the PIE module (105) to facilitate upkeep of health information and reports in the EMRI module (102) and in turn better health of the individual.

The PIE module (105) is preferably composed of two sub-modules such as share sub-module (1902) and search sub-module (1903), where these share and search sub-modules (1902, 1903) can be interfaced with an user interface and processing system (1901) through which the information can be accessed from the share and search sub-modules (1902, 1903). The share and search sub-modules (1902, 1903) are connected to a coder and database storage device (1904) for sharing and searching of ‘My experiences with symptoms’ of the individual user. The coder and database storage device (1904) stratifies and stores the shared ‘My experiences with symptoms’ based on several criteria with the help of share sub-module (1902), which facilitates search for the ‘My experiences with symptoms’ as per search criteria with the help of search sub-module (1903). The search sub-module (1903) is configured to search for the ‘My experiences with symptoms’ as per search criteria performed by various steps 1905-1914. Initially, as depicted at step 1905, the search sub-module (1903) allows the user to understand and recognize the contents of ‘My experiences with symptoms’ shared in the share sub-module (1902). Then, as depicted at step 1906, applicability and usefulness of the contents of ‘My experiences with symptoms’ are determined, based on the recognized contents. Then, as illustrated at steps 1907 and 1908, the search sub-module (1903) allows the user to identify specific inputs of good practice, which enhances the user's awareness about the symptom(s) and their uniqueness.

On one side, as shown at steps 1909 and 1910, the search sub-module (1903) leads the user to realize the importance of upkeep of structured and organized health documentation and to create or edit the contents of various sub-modules of the medical information and reports in the EMRI module (102). It also indicates the sub-modules (302-310) of the EMRI module (102) for the user to understand and recognize each sub-module (302-310) of the EMRI module (102) for including new abnormalities, symptoms, allergies, habits, work hazards family health issues, preventive health checks, maintaining reports, describing symptoms more precisely along with their uniqueness, modifying preventive health care plan/parameters, their frequency, etc, reviewing childhood developmental issues and ensuring reviews with doctor, listing all pregnancy issues as appropriate, more frequent doctor reviews during pregnancy and post delivery, recording and implementing doctor's advice diligently, and updating effectiveness of medicines/medical intervention. Then, as mentioned at step 1911, the search sub-module (1903) helps the user to undertake structured preventive healthcare practices.

On the other side, as shown at step 1912, the search sub-module (1903) leads the user to seek medical intervention from a qualified medical professional without delay. Thus, as depicted at steps 1910-1914, the share and search sub-modules (1902, 1903) of the PIE module (105) help the user to provide relevant and factual inputs {with the help of EMRI module and as a result of enhanced awareness of the user about symptom(s) and their uniqueness} for diagnosis during the consultation with the medical professional, which derives the benefits of doctor being more informed about patient's health background, trauma mitigation and avoidance, enhanced quality of health and lower cost of upkeep of health.

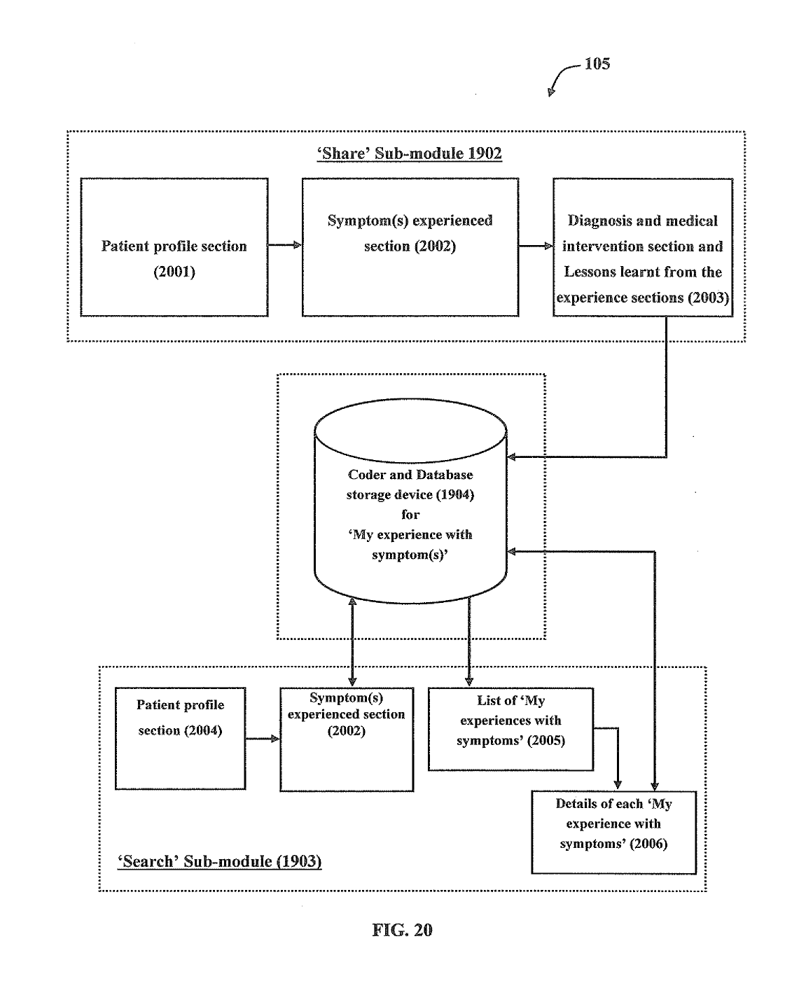

FIG. 20 illustrates a detailed block diagram of the PIE module (105) of FIG. 19, in accordance with an exemplary embodiment of the present invention. The share sub-module (1902) allows the user to share and record the ‘My experiences with symptoms’ of the individual user with the help of user interface (1901), where the share sub-module (1902) is preferably composed of a ‘profile’ section (2001) for recording information related to user (patient) profile, a symptoms experienced section (2002) for selecting and recording information related to the symptoms experienced by the individual user, diagnosis and medical intervention & lessons learnt from the experience sections (2003) for recording information related to the experiential learning from the diagnosis and medical intervention undergone by the individual user in dealing with symptoms. The information entered into the share sub-module (1902) is saved and stored in the coder and database storage device (1904) as cases shared of ‘My experiences with symptoms’.

The search sub-module (1903) allows the user to search the ‘My experiences with symptoms’ of the individual user with the help of user interface (1901), where the search sub-module (1903) is preferably composed of a ‘profile’ section (2004) for entering search criteria related to patient profile, and the symptoms experienced section (2002) for selecting and entering search criteria related to the symptoms experienced by the individual user. Once the search criteria is entered and completed in the sections (2004, 2002) of the search sub-module (1903), then the search sub-module (1903) displays a list (2005) of along with reference numbers, from the coder and database storage device (1904) based on the search criteria entered in it. Then, the details and health information of individual case of ‘My experiences with symptoms’ (2006) is selected and accessed from the list of ‘My experiences with symptoms’. In case no matching is found based on the search criteria entered in it, the search sub-module (1903) displays a message “no match is found for the search criteria”.

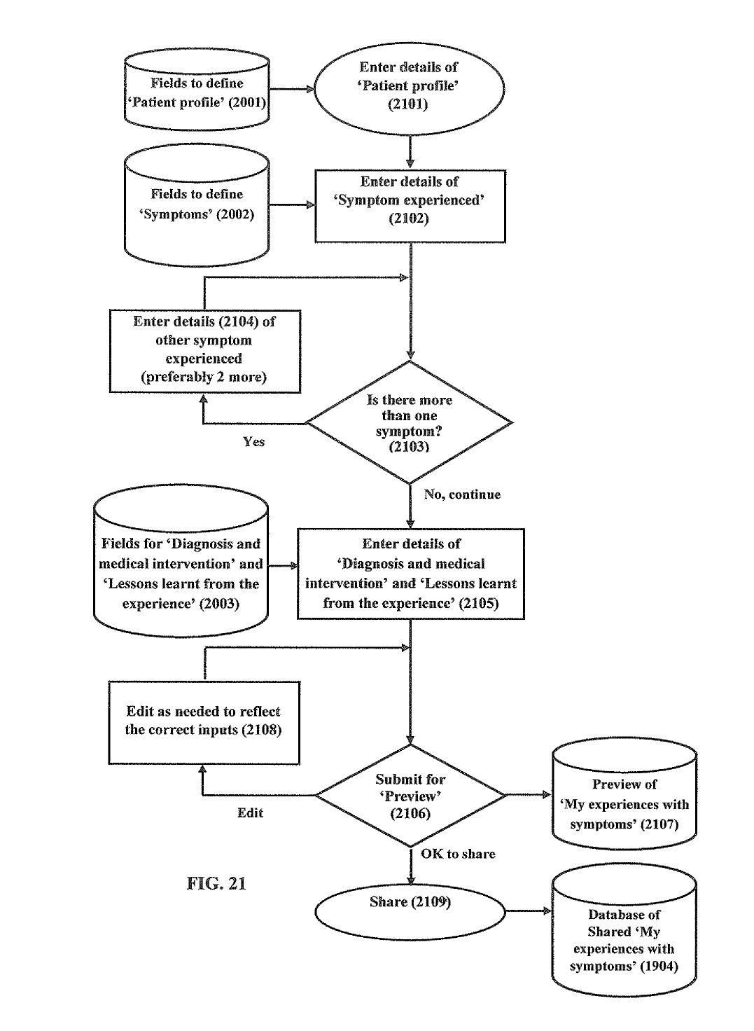

FIG. 21 illustrates a flowchart depicting a functional process of the share sub-module (1902) of the PIE module (105), in accordance with an exemplary embodiment of the present invention. As depicted at step 2101, details of patient profile are entered and recorded according to fields of the profile section (2001) of the share sub-module (1902) through the user interface (1901). The patient profile is defined by the fields of the profile section (2001), where the fields of the profile section (2001) preferably include age group (when diagnosed), gender, period (when diagnosed, for example before 2000, 2001-2005, 2006-1010, 2010-2015 and so on), country of residence, ZIP or PIN code, natural sub group (such as white, black, Asian, Asian Indian, etc), mail identification, etc. Then, as illustrated at step 2102, details of symptom experienced are entered and recorded according to fields of the symptom experienced section (2002) of the share sub-module (1902) through the user interface (1901).

The symptoms are defined by the fields of the symptom experienced section (2002), where the fields of the symptom experienced section (2002) preferably include three major fields in ‘body region’, ‘in body part or group’ and ‘symptom’. Initially, the body region field is defined and displayed with elements preferably such as head and neck region, upper limb region, chest region (Thorax), middle region, back region, pelvis region, lower limb region and general. Then, one of the elements in the body region field is selected in the symptom experienced section (2002) and the body part or group field is defined and displayed with elements relating to the selected element of the body region field. Finally, one of the elements in the body part or group field is selected in the symptom experienced section (2002) and the symptom field is defined and displayed with symptom elements relating to the selected element of the body part or group field (of the body region).

For example, the body region field is defined and displayed with the elements preferably such as head and neck region, upper limb region, chest region (Thorax), middle region, back region, pelvis region, lower limb region and general. In that, if the head and neck region is selected in the body region field, then the body part or group field displays elements preferably such as brain, cheek or face or forehead, ears, eyes, gums, head, jaw, mouth or lips, neck, nose, tooth, tongue, etc, which allows the user to easily trace and select the elements of the body part or group field. Thereafter, if the brain element is selected in the body part or group field, the symptom field displays elements preferably such as coma, decline/loss—in intellectual functions (such as to perceive, reason out, judge or solve problems, etc), decline/loss—in intellectual functions (such as to plan, coordinate and perform normal or complicated tasks), decline/loss—in mental functions—which is going down steadily, etc, which allows the user to easily trace and select/record the elements of the symptom. field. The symptoms listed are preferably traceable to the body part or group of the body region. These examples are only for the purpose of understanding the details about the share sub-module (1902) in the PIE module (105).

Further, as shown at steps 2103 and 2104, if there are more symptoms to be entered, details of other symptom experienced (preferably 2 or more) are entered and recorded according to the fields of the symptom experienced section (2002) of the share sub-module (1902) through the user interface (1901). Similarly, as shown at steps 2103 and 2105, if there are no more symptoms to be entered, then, details of diagnosis, medical intervention and related details are entered and recorded according to fields of the sections diagnosis and medical intervention & lessons learnt from the experience (2003) of the share sub-module (1902) through the user interface (1901). The diagnosis, medical intervention and related details are defined by the fields of the diagnosis and medical intervention & lessons learnt from the experience sections (2003), where the fields of the diagnosis and medical intervention & lessons learnt from the experience sections (2003) preferably include abnormality diagnosed, tests and results to confirm diagnosis, possible causes, medical intervention, effectiveness of medical intervention, learning from the experience, etc. Lessons learnt from the experience section may include inputs such as the user awareness of the symptoms in the early stages, earliest form of symptoms experienced, symptom(s) level at which medical intervention was sought, any delay by the user in seeking medical intervention, precaution/steps that may have helped avoid the abnormality/mitigate the trauma and tangible benefits of timely medical intervention etc.

Then, as depicted at steps 2106 and 2107, the details entered in the profile section (2001), the symptom experienced section (2002) and the diagnosis and medical intervention & lessons learnt from the experience sections (2003) of the share sub-module (1902) are submitted for preview of the content of the shared experience in the share sub-module (1902). Thereafter, as mentioned at step 2108, the contents of the shared experience previewed in the share sub-module (1902) can be reviewed and edited to reflect and correct the contents of the shared experience. Finally, as shown at step 2109, if the contents of the shared experience previewed in the share sub-module (1902) are satisfied and finalized, the contents of ‘the personal profile and symptoms experienced and the experiential learning in dealing with symptoms and related diagnosis, medical intervention’ in the share sub-module (1902) are shared and stored in the database storage device (1904) as ‘My experience with symptoms’.

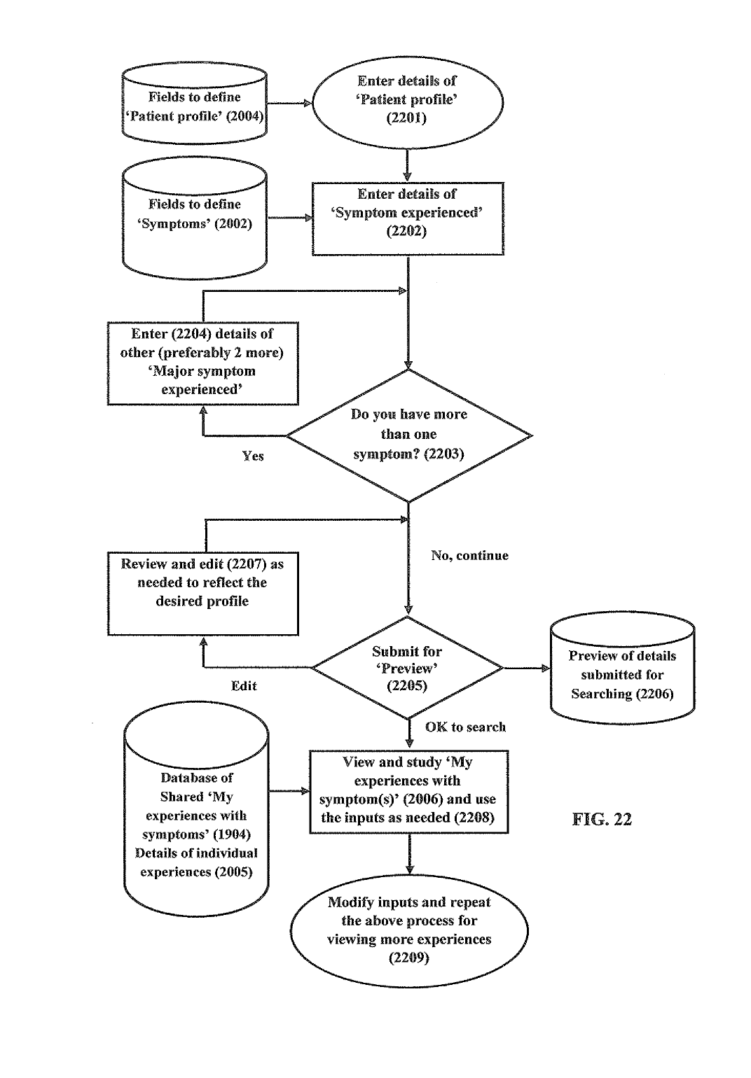

FIG. 22 illustrates a flowchart depicting a functional process of the search sub-module (1903) of the PIE module (105), in accordance with an exemplary embodiment of the present invention. As depicted at step 2201, details of patient profile are entered and recorded according to fields of the profile section (2004) of the search sub-module (1903) through the user interface (1901). The patient profile is defined by the fields of the profile section (2004), where the fields of the profile section (2004) preferably include age group, gender, period, country of residence, natural sub group (such as white, black, Asian, Asian Indian, etc), etc. Then, as illustrated at step 2202, details of symptom experience are entered and recorded according to fields of the symptom experienced section (2002) of the search sub-module (1903) through the user interface (1901).

The symptoms are defined by the fields of the symptom experienced section (2002), where the fields of the symptom experienced section (2002) preferably include three major fields in body region, in body part or group and symptom. Initially, the body region field is defined and displayed with elements such as head and neck region, upper limb region, chest region (Thorax), middle region, back region, pelvis region, lower limb region and general. Then, one of the elements in the body region field is selected in the symptom experienced section (2002) and the body part or group field is defined and displayed with elements relating to the selected element of the body region field. Finally, one of the elements in the body part or group field is selected in the symptom experienced section (2002) and the symptom field is defined and displayed with symptom elements relating to the selected element of the body part or group field (of the body region).

Further, as shown at steps 2203 and 2204, if there are more symptoms to be entered, details of other major symptom experienced (preferably 2 or more) are entered and recorded according to the fields of the symptom experienced section (2002) of the search sub-module (1903) through the user interface (1901). Similarly, as shown at steps 2203, 2205 and 2206, if there are no more symptoms to be entered, then the details entered in the profile section (2004) and the symptom experienced section (2002) of the search sub-module (1903) are submitted for preview of the search details entered in the search sub-module (1903). Thereafter, as mentioned at step 2207, then the search details previewed in the search sub-module (1903) can be reviewed and edited to reflect and correct the desired search detail profile. Finally, as shown at step 2208, if the search details previewed in the search sub-module (1903) are satisfied and finalized, the list of matching cases of the individual ‘My experiences with symptoms’ (2005) are searched, acquired and accessed from the database storage device (1904) based on the search details entered in the search sub-module (1903) for viewing and studying the individual experiences of the details of each ‘My experiences with symptoms’ (2006) as well as determining its usefulness and identifying its beneficial inputs. Further, as depicted at step 2209, the details (search criteria) entered in the search sub-module (1903) are modified to repeat the above steps 2201-2208 for viewing and studying more cases of the individual experiences in dealing with symptoms.

Various embodiments of the invention are now described with reference to the individual figures from 1 to 22. The embodiments of the present invention as described and illustrated in the figures could be arranged and designed in a wide variety of configuration. Thus, the above detailed description of several embodiments of the present invention, as represented in the figures, is not intended to limit the scope of this invention, as claimed, but is merely a representative of the embodiments of invention.

The various illustrative blocks, flow charts, steps, algorithms described in connection with the embodiments disclosed herein may be implemented as electronic hardware, software or combination of both. The above descriptions have been described in terms of the functionality and thus may be implemented as electronic hardware, software or combination of both. The person skilled in the art may implement the described functionality in varying ways for each application. However, such implementation decisions should not be interpreted as a departure from the scope of the invention presented.

The steps, algorithm and methods described in connection with the embodiments disclosed herein may be integrated or embodied directly in hardware, in a software module executed by a processor or by their combination. A software module may reside in devices such as a RAM memory, Flash memory, ROM memory, EPROM memory, EEPROM memory, registers, hard disc, removable disc (such as USB), CD ROM or any other form of storage known in the art or that may be developed in future. An exemplary storage medium is coupled to the processor such that the processor can read information from and write information to the storage medium. As depicted, the storage medium may be integral to the processor. The processor and the storage device may reside inside in an ASIC. ASIC may reside inside a user terminal.

The methods, steps described may be interchanged to meet the functions described. Modifications, changes and variations which will be apparent to those skilled in the art may be made in the arrangement, operations and details of methods and systems of the present invention disclosed herein without departing from the spirit and scope of invention.

What is claimed:

1. A method for creating and recording medical information of an individual user in an integrated system of Electronic Medical Records for Individuals (EMRI) module and Patient Information Exchange (PIE) module, comprising the steps of:
collecting and recording personal details and health details of the individual user from the birth, through a user interface module of the EMRI module;
updating symptoms, treatment details, and health reports of each health consultation of the individual user in the user interface module;
recording family health details of the individual user in the user interface module;
registering medical insurance details of the individual user in the user interface module;
organizing and preparing a comprehensive health information of the individual user in the user interface module based on the personal details, the health details, the symptoms, the treatment details, the health reports and the medical insurance details;
displaying auto reminder of pending health issues for the individual user in the user interface module; and
tracking and displaying the health information of the individual user from the user interface module into a doctor interface module of the EMRI module.

2. The method of claim 1, wherein the comprehensive and chronological health information of the individual user includes various lists of information about personal details, present abnormalities, symptoms, consultation and treatment details, prescribed medicines, health test reports, allergies, habits and work hazards, family health, preventive health, childhood development and pregnancies.

3. The method of claim 1, wherein the comprehensive health information of each individual user is stored in a database storage device that is connected to the user interface module and the doctor interface module.

4. The method of claim 1, wherein the information related to account, abnormalities, reports, allergies, habits and work hazards, family health, preventive health, childhood development, pregnancies and medical insurance of the individual user are entered, stored and viewed in each sub-module of the user interface module.

5. The method of claim 1, wherein the doctor interface module is coupled with the user interface module to receive and view the health information of the user from the user interface module.

6. The method of claim 1, wherein the information related to abnormalities, reports, allergies, habits and work hazards, family health and pregnancies of the individual user in the user interface module are exported, accessed and viewed in each sub-module of the doctor interface module.

7. The method of claim 1, wherein the user interface module is preferably segmented into abnormalities sub-module, reports sub-module, allergies, habits and work hazards sub-module, family health sub-module, preventive health sub-module, childhood development sub-module, pregnancies sub-module, medical insurance sub-module and manage account sub-module.

8. The method of claim 7, wherein the pregnancies sub-module is segmented from the user interface module only when the gender is marked as ‘Female’ at the time of creating an account in the EKIRI module.

9. The method of claim 7, wherein each sub-module of the user interface module is provided with a help section to assist the user while recording the details in each sub-module.

10. The method of claim 7, wherein the details recorded in each sub-module are generated and displayed in the form of comprehensive tables in the user interface module.

11. The method of claim 7, wherein the abnormalities sub-module is configured to generate and store comprehensive information related to abnormalities of the individual user, which preferably relates to a chronological list of abnormalities, abnormality background, symptoms, consultation and treatment details, medical intervention details, test details, prescribed medicines and case history of individual abnormality.

12. The method of claim 7, wherein the abnormalities sub-module is preferably composed of abnormalities history section, symptoms and treatment detail elements, medicines prescribed elements and symptoms and treatment history elements.

13. The method of claim 12, wherein the details of age wise abnormalities of the individual user from birth are recorded in the abnormalities history section for generating a chronological and comprehensive table of abnormalities of the individual user in the user interface module.

14. The method of claim 13, wherein the abnormalities history section is preferably composed of fields of abnormalities and age when diagnosed.

15. The method of claim 12, wherein the symptoms and treatment detail elements are configured to record every consultation details of each of the abnormalities entered in the abnormalities history section through a link from the table of abnormalities, for generating a comprehensive table of symptoms and treatment details with abnormality description.

16. The method of claim 15, wherein the symptoms and treatment detail elements are preferably composed of fields of current symptoms and issues, exposure to undesirable conditions, hospital or patient reference number, doctor name, test taken, observation and diagnosis, medical intervention or procedure, medicines prescribed, doctor's advice, effectiveness of medicines or medical intervention and date of update.

17. The method of claim 12, wherein the medicines prescribed elements are configured to record details of medicines prescribed during each consultation through a link from the table of ‘symptoms and treatment’ details, and preferably composed of fields of medicine and strength, dosage unit, with respect to food, morning, noon, night, anytime of the day, and number of days along with abnormality description, doctor name and date of consulting.

18. The method of claim 12, wherein the symptoms and treatment history elements are automatically generated for each abnormality by collating information from details entered in the symptoms and treatment detail elements and the medicines prescribed elements, which provides chronological details of the treatment and medical intervention of the abnormality and accessed through a link from the table of symptoms and treatment details.

19. The method of claim 7, wherein the details regarding medical reports are uploaded and viewed in the reports sub-module that is preferably composed of upload report section and view report section.

20. The method of claim 19, wherein the upload report section is configured to upload, store and view the medical reports related to abnormalities, allergies, habits and work hazards, preventive health, childhood development, pregnancies and medical insurance of the individual user.

21. The method of claim 20, wherein the upload report section is composed of report of field, report relation field, report type field, report date field, report selection field and report upload field.

22. The method of claim 21, wherein the report of field of the upload report section is configured to select topics of abnormalities, allergies, habits and work hazards pregnancies, preventive health, childhood development and medical insurance in each sub-module of the user interface module.

23. The method of claim 22, wherein the report relation field of the upload report section is configured to automatically select sub topics that are previously entered by the user relating to the topics selected in each sub-module of the user interface module.

24. The method of claim 23, wherein after selecting the sub topics in the report relation field, report type and date are selected in the respective report type and date fields of the upload report section, and reports are selected and uploaded in the respective report selection and upload fields of the upload report section.

25. The method of claim 20, wherein the reports uploaded in the upload report section are displayed and viewed in the doctor interface module based on report of, report type and period selected in the view report section of the report sub-module.

26. The method of claim 24, wherein the reports in the report sub-module are viewed based on the report of field, the report relation field, the report type field and the date of report.

27. The method of claim 7, wherein the information relating to allergies, habits and work hazards of the individual user are recorded in the allergies, habits and work hazards sub-module that is preferably composed of known allergies, habits and work hazards section.

28. The method of claim 27, wherein the known allergies section is configured to record identified allergens along with its reaction, response and the age at which the allergy was experienced by the individual user, which are displayed in a known allergies table in the user interface module and the doctor interface module.

29. The method of claim 27, wherein the habits section is configured to capture details of habits of the individual user along with relevant details of quantity, duration, frequency and years, which are displayed in a habit table in the user interface module and the doctor interface module.

30. The method of claim 27, wherein the work hazards section is configured to capture details of professional and personal work hazards of the individual user along with relevant details of type of work/work hazards, how long (years) and effect of hazard on health which are displayed in a work hazard table in the user interface module and the doctor interface module.

31. The method of claim 7, wherein the information related to family health of the individual user are recorded in the family health sub-module that is preferably composed of family allergies section and family abnormalities section.

32. The method of claim 31, wherein the family allergies section is configured to record relationship and identified allergens along with its reaction and response of the family members of the individual user, which are displayed in a family allergies table in the user interface module and the doctor interface module.

33. The method of claim 31, wherein the family abnormalities section is configured to record relationship and identified abnormalities of the family members of the individual user, which are displayed in a family abnormalities table in the user interface module and the doctor interface module.

34. The method of claim 7, wherein the information related to preventive health plans and records are recorded in the preventive health sub-module that is preferably composed of year health planner section and template elements.

35. The method of claim 34, wherein the year health planner section is configured to prepare and record periodic preventive health plan covering details of parameter and health checks, frequency of check and period of check in year and month wise manner whereas the template elements is configured to record periodic details of health checks along with its test reports undergone by the individual user.

36. The method of claim 35, wherein the year health planner section is configured to generate auto reminder for the pending preventive health checks to the individual user based on the year health planner of the individual user.

37. The method of claim 7, wherein the information related to health records of childhood development of the individual user are recorded in the childhood development sub-module that is preferably composed of immunization section, physical development section and ability development section.

38. The method of claim 7, wherein the childhood development sub-module is configured to track and monitor the details of child development that is accessed and displayed in the form of tables in the user interface module.

39. The method of claim 37, wherein the immunization section is configured to prepare, record and track an immunization schedule of the child along with its country, recommended age, vaccines, notations, due date, given date and reactions, where due dates are automatically compiled from the account information and the details of immunization schedule are accessed and viewed in the user interface module.

40. The method of claim 39, wherein the immunization section is configured to generate auto reminder for the pending immunization to the individual user based on the immunization schedule.

41. The method of claim 37 wherein the ‘physical development’ section is configured to record and track child physical growth related to height, weight and head circumference along with its age and comments on growth, where the details of child physical growth are accessed and viewed in the user interface module.

42. The method of claim 37, wherein the ‘ability development’ section is configured to record and track child ability growth of motoring, vision, hearing, speaking, vocal, comprehension, tooth development, behavioral and social at different age groups, where the details of child abilities in the ability development section are accessed and viewed in the user interface module.

43. The method of claim 7, wherein the pregnancies sub-module is configured to generate and store comprehensive information related to pregnancies of the individual woman user, which preferably relates to a chronological list of pregnancies, pregnancy background and issues, prenatal consultation details, medical intervention details, test details, prescribed medicines and prenatal consultation history of the individual pregnancy.

44. The method of claim 43, wherein the pregnancies sub-module is preferably composed of pregnancies history section, prenatal consultation elements, medicines prescribed elements and prenatal consultation history elements.

45. The method of claim 44, wherein the details of age wise pregnancies of the individual woman user are recorded in the pregnancies history section for generating a chronological and comprehensive table of pregnancies in the user interface module.

46. The method of claim 45, wherein the pregnancies history section is preferably composed of fields of pregnancy conceived at age, special health condition, delivery type and notes on childbirth.

47. The method of claim 44, wherein the prenatal consultation elements are configured to record every prenatal consultation details of each of the pregnancies entered in pregnancies history section for generating a comprehensive table of prenatal consultation details of the pregnancies with pregnancy description.

48. The method of claim 47, wherein the prenatal consultation elements are preferably composed of fields of current health issues, missing requirements for physical and mental well-being of the woman user, hospital or patient reference number, doctor name, test taken, observation and diagnosis, medical intervention or procedure, medicines prescribed, doctor's advice, effectiveness of medicines or medical intervention and date of update.

49. The method of claim 44, wherein the medicines prescribed elements are configured to record details of medicines prescribed during each consultation entered in the prenatal consultation details and preferably composed of fields of medicine and strength, dosage unit, with respect to food, morning, noon, night, anytime of the day, and number of days, along with abnormality description, doctor name and date of consulting.

50. The method of claim 44, wherein the prenatal consultation history elements are automatically generated for each pregnancy by collating information from details entered in the prenatal consultation elements and the medicines prescribed elements, which provides chronological details of the consultation and medical intervention of the pregnancy.

51. The method of claim 7, wherein the information related to medical insurance and claim details of the individual user are recorded and maintained in the medical insurance sub-module.

52. The method of claim 51, wherein the information about medical insurance preferably include insurance company name, policy number, secondary number, policy coverage amount, premium amount, policy begin date, policy end date, contact details, and link to claims and payment receipt.

53. The method of claim 51, wherein the information about claim details preferably include claim reason, name of hospital or lab or pharmacy, receipt number, date, amount, payment receipt and comments.

54. The method of claim 51, wherein the medical insurance sub-module is configured to generate auto reminder for non-coverage of insurance or current insurance coverage details, which is displayed to the individual user in the user interface module.

55. The method of claim 7, wherein the information related to user account is recorded and maintained in the manage account sub-module.

56. The method of claim 55, wherein the manage account sub-module is preferably composed of an account information section to allow the user to modify, edit and change any account related details about the user for a given username, and a change password section to allow the user to change the password.

57. The method of claim 56, wherein the user account information section is registered with details that preferably includes user name, first name, last name, gender, date of birth, password, confirm password, address, city, zip or pin code, country, email identification, home phone number, mobile phone number, blood group and security password question.

58. The method of claim 56, wherein the change password section is registered with password details that preferably includes user name, new password and confirm new password.

59. The method of claim 1, wherein the doctor interface module is preferably segmented into abnormalities sub-module, reports sub-module, allergies, habits and work hazards sub-module, family health sub-module and pregnancies sub-module for retrieving and displaying the respective health information and reports of the individual user recorded in the respective sub-modules of the user interface module.

60. The method of claim 7, wherein the comprehensive health information recorded in each of the abnormalities sub-module, the reports sub-module, the allergies, habits and work hazards, the family health sub-module and the pregnancies sub-module of the user interface module are automatically exported and accessed in the doctor interface module.

61. A method for sharing and searching user experience with symptoms and medical intervention details in an integrated system of Electronic Medical Records for Individuals (EMRI) module and Patient Information Exchange (PIE) module, comprising the steps of:
acquiring and recognizing experiences of ‘My experiences with symptoms’ by an individual user in a share sub-module of the PIE module through an user interface;
determining applicability and usefulness of sharing of ‘My experiences with symptoms’ in public domain, and recording the same in the share sub-module;
stratifying and storing the ‘My experiences with symptoms’ in a coder and database storage device;
searching and identifying cases of ‘My experiences with symptoms’ for specific symptoms from the coder and database storage device based on a search criteria selected and entered in a search sub-module of the PIE module;
displaying a list of user shared cases of ‘My experiences with symptoms’ from the share sub-module that matches with the search criteria entered in the search sub-module; and
searching and identifying specific case of ‘My experiences with symptoms’ from the list of ‘My experiences with symptoms’ in a search sub-module of the PIE module;

62. The method of claim 61, wherein the share sub-module and the search sub-module are connected to the coder and database storage device for sharing and searching of shared cases of ‘My experiences with symptoms’ of the individual user from the coder and database storage device.

63. The method of claim 61, wherein the share sub-module is preferably composed of a profile section, symptom experienced section, diagnosis and medical intervention section and lessons learnt from the experience section for recording information related to ‘My experiences with symptoms’ by the individual user.

64. The method of claim 61, wherein in the share sub-module, the method further comprises the steps of:
recording information related to user profile based on fields defined by the profile section;
selecting and recording information related to symptoms experienced by the individual user based on fields defined by the symptom experienced section;
recording information related to ‘experiential learning with symptoms and related medical intervention’ (My experiences with symptoms) by the individual user, based on fields defined by the diagnosis and medical intervention section and the lessons learnt from the experience section; and
sharing, stratifying and storing the shared experience as ‘My experiences with symptoms’ by the individual user along with the user profile in the coder and database storage device.

65. The method of claim 64, wherein the fields of the profile section preferably include age group, gender, period (when diagnosed), country of residence, ZIP/PIN code, natural subgroup, and mail identification.

66. The method of claim 64, wherein the fields of the symptom experienced section include body region field which preferably includes head and neck region, upper limb region, chest region (Thorax), middle region, back region, pelvis region, lower limb region and other body region, from which a specific body part of the body region is selected from another field and then the symptom associated with that body part is selected from yet another field.

67. The method of claim 64, wherein the fields of the diagnosis and medical intervention section preferably include abnormality diagnosed, tests and results to confirm diagnosis, possible causes, medical intervention, effectiveness of medical intervention, and learning from the experience.

68. The method of claim 64, wherein the fields of the lessons learnt from the experience section preferably include user awareness of the symptoms in the early stages, earliest form of symptoms experienced, symptom(s) level at which medical intervention was sought, time delay by the user in seeking medical intervention, precaution/steps that may have helped avoid the abnormality/mitigate the trauma and tangible benefits of timely medical intervention etc.

69. The method of claim 64, wherein the information recorded in the profile section, the symptom experienced section, the diagnosis and medical intervention section and the lessons learnt from experience section are previewed (ie preview of ‘My experiences with symptoms’) and edited in the share sub-module before sharing the experiences as ‘My experiences with symptoms’.

70. The method of claim 61, wherein the search sub-module is preferably composed of a profile section for entering search criteria related to patient profile, and a symptom experienced section for selecting and entering search criteria related to the symptoms experienced by the individual user.

71. The method of claim 61, wherein in the search sub-module, the method further comprises the steps of:
recording information related to user profile based on search criteria fields defined by the profile section;
selecting and recording information related to symptoms experienced by the individual user based on search criteria fields defined by the symptom experienced section;
searching and identifying the user experience for specific symptoms and medical intervention from the coder and database storage device with respect to the information selected and recorded in the search criteria fields of the profile section and the symptom experienced section; and
displaying a list of user experience of ‘My experiences with symptoms’ for selected symptoms from the share sub-module that matches with the search criteria selected in the search sub-module,
searching and identifying specific case of ‘My experiences with symptoms’ from the list of ‘My experiences with symptoms’ in a search sub-module of the PIE module.

72. The method of claim 71, wherein the fields of the profile section preferably include age group, gender, time period, country of residence and natural sub group.

73. The method of claim 71, wherein the fields of the symptom experienced section include body region field which preferably includes head and neck region, upper limb region, chest region (Thorax), middle region, back region, pelvis region, lower limb region and other body region, from which a specific body part of the body region is selected from another field and then the symptom associated with that body part is selected from yet another field.

74. The method of claim 71, wherein the information recorded in the profile section and the symptom experienced section are previewed and edited in the search sub-module before searching for the user experiences of symptoms and medical intervention.

75. The method of claim 71, wherein the search sub-module displays a list of shared cases of ‘My experiences with symptoms’ along with reference numbers from the coder and database storage device based on the search criteria entered in it.

76. The method of claim 75, wherein the details of the selected cases are accessed and displayed from the list of shared cases of ‘My experiences with symptoms’ in the search sub-module.

77. The method of claim 61, wherein the search sub-module of the PIE module aids the user to structure and organize the health information and reports in each sub-module in the EMRI module while creating and recording the medical information of the individual user in the EMRI module.
